(19) United States
(12) Patent Application Publication
(10) Pub. No.: US 2026/0087521 A1
(43) Pub. Date: Mar. 26, 2026

(54) DYNAMIC AD AUDIENCE OPTIMIZATION AND STAGE TRANSITION FRAMEWORK

(71) Applicant: Microsoft Technology Licensing, LLC, Redmond, WA (US)

(72) Inventors: Lijun Peng, Sunnyvale, CA (US); Xinruo Jing, Palo Alto, CA (US); Xueqian Tang, Mountain View, CA (US); Yuzhang Hu, San Jose, CA (US); Tao Cai, Sunnyvale, CA (US); Ruiqi Li, San Carlos, CA (US); Yi Wu, Palo Alto, CA (US)

(73) Assignee: Microsoft Technology Licensing, LLC, Redmond, WA (US)

(21) Appl. No.: 18/891,431

(22) Filed: Sep. 20, 2024

(51) Int. Cl. G06Q 30/0251; G06N 3/048; G06Q 30/0204; G06Q 30/0241; G06Q 30/0242

(52) U.S. Cl. CPC G06Q 30/0269; G06N 3/048; G06Q 30/0205; G06Q 30/0244; G06Q 30/0276

(57) ABSTRACT

Artificial intelligence (AI) techniques for connection networking are described. A method comprises receiving an input vector by a multi-tower machine learning (ML) model for a content delivery system of a connection network system, generating a set of user embeddings from a first vector of the input vector by a first tower of the multi-tower ML model based on the activity data associated with users of the connection network system, generating a set of campaign embeddings from a second vector of the input vector by a second tower of the multi-tower ML model based on the textual description of the content delivery campaign, generate a metric based on a subset of the user embeddings and a subset of the campaign embeddings, selecting audience user identifiers based on the metric, and sending content items for the content delivery campaign to electronic devices of the audience user identifiers.

### BACKGROUND

A social networking system is an online platform where connections can create profiles, connect with friends, family, and colleagues, and share various types of content such as photos, videos, and status updates. These platforms often offer features like messaging, groups, events, and news feed to keep connections engaged and connected. connection network systems facilitate communication, networking, and content sharing among connections, creating a digital community where people can interact and engage with others in their social circle or with like-minded individuals. Similarly, a connection network system allows individuals to connect with colleagues, potential employers, and other professionals in their industry. It is geared towards professional networking, job searching, and recruiting. Professionals can create a profile showcasing their work experience, skills, and education, as well as connect with others in their field. Connection network systems also provide a platform for sharing content, participating in discussions, and accessing industry news and insights.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a connection network system in accordance with one embodiment.

FIG. 2 illustrates a system in accordance with one embodiment.

FIG. 3 illustrates a content delivery system in accordance with one embodiment.

FIG. 4 illustrates a machine learning architecture in accordance with one embodiment.

FIG. 5 illustrates a transformer model in accordance with one embodiment.

FIG. 6 illustrates a logic diagram in accordance with one embodiment.

FIG. 7 illustrates a state machine in accordance with one embodiment.

FIG. 8 illustrates a data flow diagram in accordance with one embodiment.

FIG. 9 illustrates a logic flow in accordance with one embodiment.

FIG. 10A illustrates a timing diagram in accordance with one embodiment.

FIG. 10B illustrates a timing diagram in accordance with one embodiment.

FIG. 11 illustrates an apparatus in accordance with one embodiment.

FIG. 12 illustrates a logic diagram in accordance with one embodiment.

FIG. 13 illustrates a logic flow in accordance with one embodiment.

FIG. 14 illustrates a logic flow in accordance with one embodiment.

FIG. 15 illustrates an artificial neural network (ANN) in accordance with one embodiment.

FIG. 16 illustrates a computer-readable storage medium in accordance with one embodiment.

FIG. 17 illustrates a computing architecture in accordance with one embodiment.

FIG. 18 illustrates a communications architecture in accordance with one embodiment.

### DETAILED DESCRIPTION

Embodiments are generally directed to a connection network system. Some embodiments are particularly directed to artificial intelligence (AI) and machine learning (ML) techniques to support applications and/or services provided by a connection network system. Although exemplary embodiments are described in connection with a particular AI system or an ML model, the principles described herein can also be applied to other types of AI systems and ML models as well. Embodiments are not limited in this context.

### Overview

A connection network system may provide access to a large amount of electronic content aimed at professional networking and career development. For example, a connection network system may list employment opportunities posted by employers across different industries, professional profiles with detailed information about users of the connection network system (e.g., work experience, skills, and endorsements), articles or posts created by users and industry leaders covering various topics (e.g., business, technology, and career advice), online courses and tutorials on a wide range of professional skills and subjects, company profiles offering insights about a company (e.g., company culture, job openings, and industry news), connections and networking tools to connect with and recommend other professionals, forums and discussion groups where users can share ideas and discuss industry trends, and other types of content designed to facilitate professional growth and industry engagement.

A connection network system collects a variety of data associated with users of the platform in accordance with privacy policies which govern how this information is collected, used, and shared. This user data includes basic profile information such as name, job title, industry, location, educational background, and work history. Additionally, the connection network system may collect activity data for users representing various interactions and behaviors that users exhibit while on the platform. Examples of activity data include profile updates, content engagement, search and navigation behavior, job activities, networking activities, group participation, skill endorsements and recommendations, advertisement engagement, learning activities, event participation, follower's activities, interactions with external content, engagement patterns, behavioral trends, and so forth.

In some cases, a connection network system may enhance network services offered by the connection network system based on the user data and activity data of its users. Examples of network services include messaging services, search services, ranking services, recommendation services, advertising services, content delivery services, and so forth. For example, a connection network system may use activity data to personalize user experiences, optimize content displayed in feeds, improve targeted advertising, and enhance platform features. It also plays a role in developing analytics and reporting tools, helping users and businesses understand their network reach, content effectiveness, and engagement with their audience.

A connection network system may offer a content delivery system that delivers electronic content items to users based on user data and activity data. For example, the content delivery system may recommend content items such as posts or articles for a user feed based on group participation, educational courses for a skill based on job title, or upcoming events based on previously attended events. In particular, the content delivery system may deliver content items such as advertisements (ads) specifically targeted to an audience of users based on user data or activity data. For instance, a content producer such as an advertiser may create a marketing campaign to deliver a series of advertisements for a product or service to an audience of users of the connection network system.

Identifying an audience of users relevant to a given marketing campaign is an iterative process, sometimes referred to as an audience expansion (AE) process. The content delivery system selects an initial audience of users for a marketing campaign, sometimes referred to as a seed audience, and it begins delivery of advertisements to members of the seed audience. The content delivery system collects activity data such as user engagement with the advertisements, and it uses the activity data to modify the seed audience (e.g., adding or removing users) to improve future user engagement. The AE process continues in an iterative manner until the content delivery system identifies a most relevant audience of users or user segment for a given marketing campaign, sometimes referred to as a performant audience (PA) segment.

Identifying a PA segment from among millions or billions of users of a connection network system is a tedious and time consuming task. Therefore, the content delivery system may utilize various machine learning (ML) models to assist in this task. However, there are several technical challenges to implementing ML models for a global online system such as a connection network system. For example, efficiently finding relevant user candidates for marketing campaigns in a large audience pool is a technically difficult process. An ML model executing on high-performance computing (HPC) platforms may take hours or even days to find a PA segment for a given marketing campaign. This problem is exacerbated when the content delivery system is managing a large number of marketing campaigns (e.g., often hundreds of thousands) in various stages of AE simultaneously and in parallel using servers in different geolocations around the world. Further, timing becomes a problem for launching new marketing campaigns. An advertiser may desire to start actively delivering advertisements to a seed audience immediately upon launch of a new campaign, rather than waiting hours or days for a complete PA segment to be identified for the new campaign. Another problem is that AE tasks for a global online system may require use of multiple ML models. This requires larger training datasets, more frequent training, greater inference flow scheduling, and more frequent model publishing. Still another problem is that the ML models perform AE tasks using various campaign attributes associated with a marketing campaign, such as a campaign start date, campaign stop date, number of advertisements, target demographics, types of products and/or services, geo-locations, languages, and a host of other attributes associated with a given campaign. When an advertiser changes any of the campaign attributes after a campaign has started, the ML models must reinitialize the entire AE process to use the new set of campaign attributes. This reset may cause a delay of hours or days as the content delivery system attempts to find a new PA segment relevant to the new campaign attributes. Other technical problems exist as well.

Embodiments solve these and other technical challenges. Embodiments are generally directed to AI and ML techniques to support various network services for an online connection network system. Some embodiments are particularly directed to a novel AI architecture and framework that implements various ML models trained and deployed to perform inferencing operations in support of a network service. Non-limiting examples of network services include search services, ranking services, recommendation services, advertising services, content delivery services, and other types of network services.

In various embodiments, a connection network system may use an improved content delivery system to provide a content delivery service to its users (e.g., individuals, members, entities, groups, etc.). The content delivery system is generally designed to deliver electronic content items to users based, at least in part, on user data and activity data of users of the connection network system. In particular, the content delivery system may deliver content items such as advertisements specifically targeted to an audience of users based on user data or activity data. For instance, a content producer such as an advertiser may create a marketing campaign to deliver a series of advertisements over time for a product or service of a business entity to an audience of users of the connection network system.

In various embodiments, the content delivery system may train and deploy one or more ML models to perform various downstream tasks in support of advertising services for the connection network system. For example, the content delivery system may use multiple ML models to automatically identify users relevant to a content delivery campaign. Examples of a content delivery campaign includes a marketing campaign or an advertising campaign. Examples of a content producer includes a user, an advertiser, or a business entity.

In particular embodiments, the content delivery system uses multiple ML models to support an auto-targeting (AT) task and an audience expansion (AE) task for a content delivery campaign on behalf of a content producer. For example, the content delivery system may use an AT model for an AT task to select a seed audience for a content delivery campaign. The content delivery system begins delivery of content items, such as advertisements, to members of the seed audience. The content delivery system collects activity data of the members of the seed audience, such as user engagement with the advertisements. The content delivery system uses an AE model for an AE task that periodically, aperiodically or continuously modifies the seed audience (e.g., adding or removing users) based on the collected activity data to improve future user engagement. The AE model performs the AE task in an iterative manner until it converges on a performant audience (PA) segment for the content delivery campaign.

In particular embodiments, the content delivery system may implement one or more AT models and/or AE models to automatically identify users relevant to a content delivery campaign in discrete campaign stages. For example, the AT model and/or the AE model may operate in multiple campaign stages, where each campaign stage successively identifies an increasingly relevant audience of users for the marketing campaign, until the AE model converges on a final PA segment for the marketing campaign. In one embodiment, for example, the campaign stages may include a cold campaign stage, a warm campaign stage, and a hot campaign stage. In the cold campaign stage, an AT model and/or an AE model may generate “cold data” such as a seed audience of users. In the warm campaign stage, the AT model and/or an AE model may generate “warm data” such as an intermediate audience of users derived from activity data of users, where the activity data includes content related activities (e.g., interactions between users and specific content items) and non-content related activities (e.g., interactions between users and general services of an online system). In the hot campaign stage, the AT model and/or an AE model may generate “hot data” derived from further activity data of users. In one embodiment, for example, the hot data may comprise a final PA segment of users for the content delivery campaign.

The campaign stages may define various states of data representing groups of users suitable for an audience of users for the content delivery campaign. A campaign state machine defines the various states of data, such as a cold state (State_Cold), a warm state (State_Warm), and a hot state (State_Hot) which controls an offline data flow of jobs. In a cold state, an initial audience of users (e.g., seed audience) for the cold state are created from an AT model, such as a generative AI model or a behavioral generative (BG) model. The content delivery system delivers advertisements to an exact match of the initial users. In a warm state, an intermediate audience of users is ready (e.g., warm data) for delivery of advertisements. The content delivery system enters a warm state after an interval of time (e.g., 2 to 3 days) after cold start, and it keeps refreshing on a periodic basis (e.g., every 6 hours). In a hot state, a PA segment of users is ready (e.g., hot data) for delivery of advertisements. The content delivery system enters a hot state after an interval of time (e.g., 2 to 4 days) after warm data is ready, and it keeps refreshing on a periodic basis (e.g., every 1-2 days).

In various embodiments, the content delivery system implements the AT model and/or the AE model as embedding-based retrieval (EBR) models. Identifying a PA segment from among millions or billions of users of a connection network system is a tedious and time consuming task. Therefore, the content delivery system utilizes an AT model to automatically identify a seed audience and target user-ad relevance pairs. A by-product of the AT model are member embeddings and campaign embeddings, which are applied in a downstream AE model to identify relevant user candidates for a PA segment for a given marketing campaign. In one embodiment, for example, the AE model may be implemented as an EBR model, such as a recurrent neural network (RNN) or a transformer. An EBR model is designed to make decisions or predictions based on data that is represented as a sequence of events that occur over time. For instance, in recommendation systems, each user interaction (e.g., clicks, purchases, etc.) can be treated as a discrete event. EBR focuses on representing and learning from these events to predict future events or outcomes. For example, an EBR model may be trained to receive as input various user features and campaign features, and it generates a predicted click-through rate (pCTR) metric as output. The pCTR metric represents an estimate of the probability of a user clicking on an advertisement. The content delivery system uses the pCTR metric as one basis for selecting users to add to a PA segment for a given marketing campaign. This process ensures that a marketing campaign serves advertisements that are relevant to users within a PA segment, thereby optimizing advertisement placements.

In various embodiments, the content delivery system utilizes multiple execution pipelines to support content delivery services. As previously described, efficiently finding relevant user candidates for marketing campaigns in a large audience pool is a technically difficult process. An EBR model executing on HPC platforms may take hours or even days to perform a downstream AE task to find a PA segment for a given marketing campaign. Meanwhile, an advertiser may desire to start actively delivering advertisements to a seed audience immediately upon launch of a new campaign, rather than waiting hours or days for an AE model to identify a complete PA segment for the new campaign. To better manage timing of content delivery for a new marketing campaign, the content delivery system uses multiple execution pipelines, such as an online execution pipeline and an offline execution pipeline. The online execution pipeline uses one or more EBR models for an AT task to identify seed audiences online and begins delivery of advertisements to users of the seed audience. The offline execution pipeline uses one or more EBR models to identify a PA segment offline in the background. In this way, the content delivery system can start immediate delivery of advertisements to members of the seed audience using the online execution pipeline, while the AE model continues iterating on the AE process in the background to identify a PA for the content delivery campaign using the offline execution pipeline. The content delivery model also uses a custom notification data structure to allow the offline execution pipeline to notify the online execution pipeline when certain outputs of the offline execution pipeline are ready for execution by the online execution pipeline, such as the different audiences of users defined for the various campaign stages (e.g., cold state, warm state, hot state) of the content delivery campaign.

In various embodiments, the content delivery system uses custom merge logic to merge outputs from the multiple pipelines. Merging outputs from the online execution pipeline and the offline execution pipeline is a technically difficult and time-consuming process. It also introduces risks to the stability of both pipelines if merge operations are not properly synchronized. The content delivery system implements custom merge logic to efficiently and effectively merge and synchronize outputs of EBR models from both pipelines, such as cold data, warm data, and hot data from the cold campaign stage, warm campaign stage, and hot campaign stage, respectively. After each campaign stage, when the cold data, warm data, and hot data are ready for use by the online execution pipeline, a stage controller for the offline execution pipeline executes merge logic to merge the multiple sets of user identifiers from the cold data, warm data, and hot data into a single list of user identifiers for a user audience of the content delivery campaign. As described further below, the custom merge logic further implements user reset logic to handle a case where an advertiser changes parameters or attributes for an active content delivery campaign after launch of the active content delivery campaign, thereby causing a re-launch of the AT task and/or AE task to accommodate the modified parameters or attributes. The merge logic and user reset logic uses a set of merge rules to guide the merger and/or reset process. For example, a merge rule may be based on a campaign version for the content delivery campaign at the time a user reset signal is received by the content delivery system.

In various embodiments, the content delivery system uses a novel ML architecture for embedding and inferencing operations. For example, the content delivery system uses a new multi-tower model (e.g., a two-tower model) to generate member embeddings and campaign embeddings and output a universal pCTR metric to support AT and AE tasks. A first tower generates a member embedding from a vector of member-side features, including categorical features and numerical features. The member-side features may include member attributes and activity data. A second tower generates a campaign embedding from a vector of campaign-side features, including categorical features, numerical features, a campaign identifier (ID), and textual features from a generative AI (GAI) model. The GAI model provides creative content describing a given content delivery campaign based on various campaign attributes defined for the campaign, thereby providing a rich source of campaign features for the two-tower model. Non-limiting examples of generative AI models may include transformer models such as a large language model (LLM) like a Bidirectional Encoder Representations from Transformers (BERT) model, Lightweight BERT (LiBERT) model, or a Lightweight Decoding-Enhanced BERT with Disentangled Attention (LiDeBERT) model. The two-tower model further includes a matching layer to match the member embeddings and the campaign embeddings using a similarity score, such as cosine similarity. The matching layer outputs a universal pCTR for a member-campaign pair.

A training device trains the two-tower model as a universal click model on pseudo-labels derived from click actions for landing page clicks as opposed to chargeable clicks. It incorporates creative text embeddings as features in the two-tower model for better generalization. It removes testing data (e.g., 3 days) in daily retraining for early availability of embeddings for new campaigns. A model analyzer and a model validator guides model retraining and publishing. It may also use campaign targeting facets generated from a GAI model to identify a cold-start audience as campaign side features. As a result, the two-tower model reduces a number of training datasets, requires less frequent training, reduces inference flow scheduling, and less frequent model publishing.

In various embodiments, the content delivery system uses custom user reset logic to reset the AT and/or AE process for an active content delivery campaign in response to changes in the content delivery campaign. The custom user reset logic may be separate from, or integrated with, the custom merge logic. An active content delivery campaign is a content delivery campaign that has previously been initiated by the content delivery system and is currently managed by the content delivery system. Conversely, an inactive content delivery campaign is a content delivery campaign that has been terminated by the content delivery system and is not currently managed by the content delivery system. The ML models perform AT and AE tasks for an active content delivery campaign according to various campaign attributes associated with the content delivery campaign, such as a campaign start date, campaign stop date, number of advertisements, target demographics, types of products and/or services, geo-locations, languages, and a host of other attributes associated with a given campaign. When the content delivery system detects a change in one or more of the campaign attributes for an active content delivery campaign (e.g., an ongoing campaign), the ML models must reinitialize or restart the entire AT and/or AE process tasks to use the new set of campaign attributes. This reset may cause a delay of hours or days as the content delivery system attempts to find a new PA segment relevant to the new campaign attributes. The content delivery system monitors for a user reset signal indicating a user has changed one or more of the campaign attributes of an ongoing content delivery campaign. The content delivery system uses the user reset logic to reset the campaign stages in an efficient manner that preserves, to the extent possible, output from previous campaign stages. As a result, the content delivery system decreases an amount of time associated with converging on a new PA segment that is relevant to the ongoing content delivery campaign using new campaign attributes.

The embodiments disclosed herein provide several technical solutions to technical problems faced by conventional systems. For example, efficiently finding relevant user candidates for marketing campaigns in a large audience pool is a technically difficult process. A ML model executing on HPC platforms may take hours or even days to perform a downstream AE task to find a PA segment for a given marketing campaign. This problem is exacerbated when the content delivery system is managing a large number of marketing campaigns (e.g., often hundreds of thousands) in various stages of AE simultaneously and in parallel in different geolocations around the world. Embodiments implement an AT model and an AE model as EBR models in a parallel fashion to accelerate finding a PA segment for a given content delivery campaign. Further, timing becomes a problem for launching new marketing campaigns. An advertiser may desire to start actively delivering advertisements to a seed audience immediately upon launch of a new campaign, rather than waiting hours or days for a complete PA segment to be identified for the new campaign. To solve this problem, the content delivery system uses multiple execution pipelines, such as an online execution pipeline and an offline execution pipeline. The online execution pipeline uses one or more EBR models for an AT task to identify seed audiences online and begins delivery of advertisements to users of the seed audience. The offline execution pipeline uses one or more EBR models to identify a PA segment offline in the background. Further, the content delivery system uses custom merge logic to quickly identify when an output from the offline execution pipeline is in a ready state, and it merges, synchronizes and/or transitions outputs from both execution pipelines in a fast and seamless manner while reducing stability risks of both pipelines. Another problem is that AT and AE tasks for a global online system may require use of multiple ML models. This requires larger training datasets, more frequent training, greater inference flow scheduling, and more frequent model publishing. The content delivery system described herein uses fewer ML models relative to conventional systems. Still another problem is that the ML models perform AT and AE tasks using various campaign attributes associated with a marketing campaign, such as a campaign start date, campaign stop date, number of advertisements, target demographics, types of products and/or services, geo-locations, languages, and a host of other attributes associated with a given campaign. When an advertiser changes any of the campaign attributes after a campaign has started, the ML models must reinitialize the entire AT and AE process to use the new set of campaign attributes. This reset may cause a delay of hours or days as the content delivery system attempts to find a new PA segment relevant to the new campaign attributes. The content delivery system described herein uses custom reset logic to reuse previous output from the AT and/or AE models to jumpstart the AT and/or AE tasks with the new campaign attributes. Embodiments provided other technical solutions to other technical problems as well.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### Detailed Embodiments

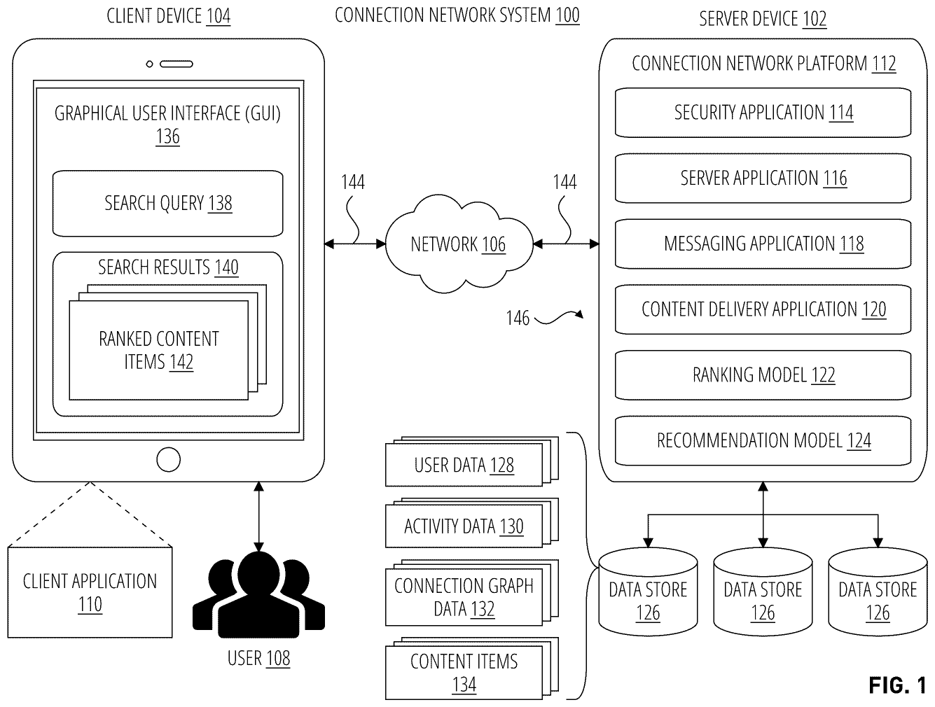

FIG. 1 illustrates a connection network system 100. The connection network system 100 is an example of an architecture or framework for an online computer and communications system designed to serve content items to an electronic device associated with a user. Embodiments are not limited to this example.

In general, the connection network system 100 may include a variety of servers, sub-systems, programs, modules, logs, and data stores. In particular embodiments, the connection network system 100 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The connection network system 100 may also include suitable components such as network interfaces, security mechanisms, load balancers, failover servers, management-and-network-operations consoles, privacy software, and other suitable components, or any suitable combination thereof.

As depicted in FIG. 1, the connection network system 100 comprises a server device 102 communicating with a client device 104 over a network 106. In operation, a user 108 interacts with a client application 110 of the client device 104 to access applications and services provided by a connection network platform 112 of the server device 102. The connection network platform 112 offers a number of network services 146 for the connection network system 100, such as network services provided by a security application 114, a server application 116, a messaging application 118, a content delivery application 120, a ranking model 122, and/or a recommendation model 124. The server device 102 has access to one or more data stores 126. The data stores 126 store information for the connection network platform 112, such as user data 128, activity data 130, connection graph data 132, and content items 134.

The connection network system 100 comprises a server device 102. In particular embodiments, a server device 102 may be an electronic device including hardware, software, or embedded logic components or a combination of two or more such components and capable of carrying out the appropriate functionalities implemented or supported by a server device 102. The server device 102 may comprise a unitary server or a distributed server spanning multiple computers or multiple data centers. The server device 102 may comprise one or more physical servers or virtual servers hosting one or more networking applications. As an example, and not by way of limitation, a server device 102 may comprise part of a larger server system comprising multiple server devices organized as a data center, an edge computing center, or a cloud-computing center. This disclosure contemplates any suitable server device 102. A server device 102 may be accessed by a network user 108 at a client device 104 via the network 106. A client device 104 may enable its user 108 to communicate with other users 108 at the server device 102, such as via messaging applications 118.

In one embodiment, for example, the server device 102 may be implemented as a web server. The web server may be used for linking the connection network platform 112 to one or more of the client devices 104 via a network 106. The web server may include a mail server or other messaging functionality for receiving and routing messages between the connection network platform 112 and one or more client devices 104. An API-request server may allow a gaming platform, a third-party system, a messaging system, and/or an AI system to access information from the connection network platform 112 by calling one or more APIs. An action logger may be used to receive communications from a web server about a user's actions on or off the connection network platform 112. In conjunction with the action log, a third-party-content-object log may be maintained of user exposures to third-party-content objects. A notification controller may provide information regarding content objects to a client device 104. Information may be pushed to a client device 104 as notifications, or information may be pulled from a client device 104 responsive to a request received from a client device 104. Authorization servers may be used to enforce one or more privacy settings of the users of the connections networking system. A privacy setting of a user determines how particular information associated with a user can be shared. The authorization server may allow users to opt in to or opt out of having their actions logged by the connection network platform 112 or shared with other systems (e.g., a third-party system), such as, for example, by setting appropriate privacy settings. Third-party-content-object stores may be used to store content objects received from third parties, such as a third-party system. Location stores may be used for storing location information received from client device 104 associated with users. Advertisement-pricing modules may combine connections information, the current time, location information, or other suitable information to provide relevant advertisements, in the form of notifications, to a user.

The connection network system 100 comprises a connection network platform 112. In particular embodiments, the connection network platform 112 may be part of a network-addressable computing system that can host an online connection network. The connection network platform 112 may generate, store, receive, and send connection networking data, such as, for example, user data 128 (e.g., user-profile data, concept-profile data, etc.), activity data 130 (e.g., user interactions with connection network platform 112), connection graph data 132 (e.g., connections between users or entities), content items 134, or other suitable data related to the online connection network. The connection network platform 112 may be accessed by the other components of the connection network system 100 either directly or via a network 106. As an example, and not by way of limitation, a client device 104 may access the connection network platform 112 using the client application 110, which may be a web browser or a native application associated with the connection network platform 112 (e.g., a mobile connection network application, another suitable application, or any combination thereof) either directly or via a network 106.

The connection network platform 112 comprises a security application 114. In particular embodiments, a security application 114 may be an application or electronic device including hardware, software, or embedded logic components or a combination of two or more such components and capable of carrying out the appropriate functionalities implemented or supported by the security application 114. The security application 114 is a network security system that encompasses a suite of technologies, policies, and practices designed to protect the integrity, confidentiality, and availability of data within the connection network platform 112 from unauthorized access, attacks, and other security threats. The security application 114 comprises components such as firewalls, which act as a barrier between trusted and untrusted networks; Intrusion Detection and Prevention Systems (IDPS) that monitor for malicious activity; antivirus and anti-malware software for removing harmful software; and Virtual Private Networks (VPNs) for secure remote access. Additionally, Data Loss Prevention (DLP), email security measures, and encryption are vital for protecting sensitive information and ensuring that only authorized users can access and understand it. Effective network security also requires rigorous access control to restrict network resources to authorized users, alongside Security Information and Event Management (SIEM) systems for real-time security alert analysis. Endpoint security further safeguards devices connected to the network, which are frequent entry points for security threats. The security application 114 implements security practices to ensure a robust defense against a wide array of cyber threats, safeguarding organizational assets and maintaining trust with stakeholders.

The connection network platform 112 comprises a server application 116. In particular embodiments, the server application 116 may be a web server to serve content information, such as content items 134, to the client application 110 of the client device 104. The server device 102 may accept an HTTP request and communicate to a client device 104 one or more HTML files responsive to the HTTP request. The server device 102 may send HTML files representing a webpage with content information for presentation via an electronic display of the client device 104 to the user 108.

In particular embodiments, the server application 116 may be an application operable to provide various computing functionalities, services, and/or resources, and to send data to and receive data from the other entities of the network 106, such as the client device 104, the connection network platform 112, a third-party server, and other electronic devices within the connection network system 100. For example, the server application 116 may be an e-commerce application, a content application, an advertisement application, a web interface, a messaging application, a video application, a webpage, and so forth.

In particular embodiments, the server application 116 may be an application for managing various applications and services provided by the online connection network hosted on the connection network platform 112. In particular embodiments, the server application 116 may include hardware, software, or embedded logic components or a combination of two or more such components for carrying out the appropriate functionalities implemented or supported by connection network platform 112. Although the server device 102 is shown with a single server application 116, it should be noted that this is not by any way limiting and this disclosure contemplates any number of server applications 116.

The connection network platform 112 comprises a messaging application 118. The messaging application 118 is software that enables users to send and receive messages, including text, images, videos, and other multimedia content, over a network 106, such as a local or broad network such as the internet. These applications support real-time communication, allowing immediate message exchange, and typically offer features like group messaging, notifications, and file sharing. They manage user identities, contacts, and groups, while ensuring security through authentication and encryption measures. Designed to operate over various network types, such as Wi-Fi or cellular data, messaging applications can also integrate with other network services and platforms, enhancing their functionality and user experience.

The connection network platform 112 comprises a content delivery application 120. The content delivery application 120 is a software tool that allows users to efficiently deliver content items to other users of the connection network platform 112 of the connection network system 100, such as content items 134 stored by one or more data stores 126 or third-party content servers. An example for the content delivery application 120 is a demand-side platform (DSP) used by users such as employees (e.g., an account manager) for an advertising entity. A DSP allows advertisers to purchase and manage ad inventory from multiple ad exchanges and networks through a single interface to implement marketing solutions for products or services of the advertiser. The content delivery application 120 allows advertisers to create, manage, and analyze their ad campaigns on the platform in accordance with a larger programmatic advertising strategy. It allows for precise targeting based on user data 128 and/or activity data 130, making it especially useful for business-to-business (B2B) or business-to-consumer (B2C) marketing campaigns. The content delivery application 120 delivers content items 134, such as a series of one or more advertisements, to an audience of users 108 of the connection network platform 112 of the connection network system 100. The content delivery application 120 assist advertisers in delivering content and ads to a professional audience by leveraging user profiles, job titles, industries, and other user data 128 and activity data 130 collected by the connection network platform 112.

The connection network platform 112 comprises various machine learning (ML) models, such as a ranking model 122. A ranking model 122 in machine learning is a ML model designed to order or prioritize a set of items based on their relevance to a given query. Unlike traditional classification or regression models, ranking models output a sorted list of items, making them essential for applications like information retrieval systems, recommendation engines, and search engines. They predict the relevance of each item, employing specialized loss functions and feature engineering to optimize ranking order. Performance is evaluated using metrics such as Mean Reciprocal Rank (MRR) and Normalized Discounted Cumulative Gain (NDCG). Examples include RankNet, LambdaRank, and LambdaMART, which are used by the connection network platform 112 to surface the most relevant results or recommendations to users.

The connection network platform 112 comprises various ML models, such as a recommendation model 124. A recommendation model 124 in machine learning is an ML model designed to predict and suggest items that are likely to be of interest to users, analyzing patterns in user behavior, preferences, and interactions to generate personalized recommendations. These models are widely used in e-commerce, streaming services, and social media to enhance user experience and engagement. Techniques include collaborative filtering, which identifies similarities between users and items based on interactions and feedback, and content-based filtering, which recommends items similar to those a user has shown interest in based on item attributes. Hybrid methods combine multiple approaches to improve accuracy and diversity. Evaluation metrics for recommendation models include precision, recall, Mean Average Precision (MAP), and Normalized Discounted Cumulative Gain (NDCG). Examples include matrix factorization techniques, deep learning approaches like neural collaborative filtering, and graph-based methods, as utilized by platforms such as YouTube, Spotify, and Amazon to provide tailored content and product suggestions.

The server device 102 comprises, or has access to, one or more data stores 126. In particular embodiments, the connections networking system 102 may include a data store 126. The data store 126 may be used to store various types of information for the server device 102 and/or the connection network platform 112. In particular embodiments, the information stored in the data store 126 may be organized according to specific data structures. In particular embodiments, the data store 126 may be a relational, columnar, correlation, or other suitable database. Although this disclosure describes or illustrates particular types of databases, this disclosure contemplates any suitable types of databases. Particular embodiments may provide interfaces that enable a client device 104 or a connection network system 100 to manage, retrieve, modify, add, or delete, the information stored in the data store 126.

In one embodiment, for example, the data store 126 stores user data 128 for the connection network platform 112. In particular embodiments, the connection network platform 112 may include user data 128 for users of the connection network platform 112. For example, the user data 128 may comprise one or more user profiles. A user profile may include, for example, biographic information, demographic information, behavioral information, social information, professional information, or other types of descriptive information, such as work experience, educational history, hobbies or preferences, interests, affinities, or location. Interest information may include interests related to one or more categories. Categories may be general or specific. The connection information may indicate users who have similar or common work experience, group memberships, hobbies, educational history, or are in any way related or share common attributes. The connection information may also include user-defined connections between different users and content (both internal and external).

In one embodiment, for example, the data store 126 stores activity data 130 for the connection network platform 112. The activity data 130 represents various activities recorded for a user 108 by the connection network platform 112. In particular embodiments, the connection network platform 112 may provide users with the ability to take actions on various types of items or objects supported (or accessible) by connection network platform 112. As an example and not by way of limitation, the items and objects may include groups or connections networks to which users of the connection network platform 112 may belong, events or calendar entries in which a user might be interested, computer-based applications that a user may use, transactions that allow users to apply to job openings or post job openings via the service, interactions with advertisements that a user may perform, content items, online games, or other suitable items or objects. A user may interact with anything that is capable of being represented in the connection network platform 112 or by an external system of a third-party system, which is separate from the server device 102 and coupled to the server device 102 via a network 106.

In one embodiment, for example, the data store 126 stores connection graph data 132 for the connection network platform 112. The connection network platform 112 may store connection graph data 132 for one or more users (e.g., members with subscription accounts) of the connection network platform 112. In one embodiment, for example, connection graph data 132 may be connection data for users organized as a graph. The graph may include multiple nodes, which may include multiple user nodes each corresponding to a particular user or multiple entity nodes each corresponding to a particular entity, such as a business entity. The graph may also have multiple edges connecting the nodes. The connection network platform 112 may provide users of the online connection network system 100 the ability to communicate and interact with other users. In particular embodiments, users may join the online connection network platform 112 via the connection network system 100 and then add connections (e.g., relationships) to a number of other users of the connection network platform 112 to whom they want to be connected. Herein, the term “connection” may refer to any other user of the connection network platform 112 or the connection network system 100 with whom a user has formed a friendship, association, or relationship via the connection network platform 112.

In one embodiment, for example, the data store 126 stores content items 134 for the connection network platform 112. The content items 134 may comprise any type of multimedia content, such as text files, multimedia files, image files, video files, graphic files, movies, articles, user feeds, advertisements for a content delivery campaign, banners, recommendations, games, messages, emojis, program code, animations, and so forth. In particular embodiments, the connection network platform 112 also includes user-generated content (UGC) objects, which may enhance a user's interactions with the connection network platform 112. User-generated content may include anything a user can add, upload, send, message, or “post” to the connection network platform 112. As an example, and not by way of limitation, a user communicates posts to the connection network platform 112 from a client device 104. Posts may include data such as status updates or other textual data, articles, job openings, company information, awards, location information, photos, videos, links, music or other similar data or media. Content may also be added to the connection network platform 112 by a third-party through a “communication channel,” such as a newsfeed or content stream.

The connection network system 100 comprises a client device 104. In particular embodiments, a client device 104 may be an electronic device including hardware, software, or embedded logic components or a combination of two or more such components and capable of carrying out the appropriate functionalities implemented or supported by a client device 104. As an example, and not by way of limitation, a client device 104 may include a computer system such as a desktop computer, notebook or laptop computer, netbook, a tablet computer, e-book reader, global positioning system (GPS) device, camera, personal digital assistant (PDA), handheld electronic device, cellular telephone, smartphone, wearable device, other suitable electronic device, or any suitable combination thereof. This disclosure contemplates any suitable client device 104. A client device 104 may enable a network user at a client device 104 to access a network 106. A client device 104 may enable its user 108 to communicate with other users 108 at other client devices 104, such as via messaging application 118.

The connection network system 100 comprises a client application 110. In particular embodiments, a client device 104 may include a client application 110, which may be a web browser, and may have one or more add-ons, plug-ins, or other extensions. A user 108 at a client device 104 may enter a Uniform Resource Locator (URL) or other address directing a web browser to a particular server device 102 such as a server or server data center for a connection network platform 112, and the web browser may generate a Hyper Text Transfer Protocol (HTTP) request and communicate the HTTP request to the server device 102. The server device 102 may accept the HTTP request and communicate to a client device 104 one or more Hyper Text Markup Language (HTML) files responsive to the HTTP request. The client device 104 may render a web interface (e.g. a webpage) based on the HTML files from the server for presentation via an electronic display of the client device 104 to the user 108. This disclosure contemplates any suitable source files. As an example, and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as Asynchronous JAVASCRIPT (AJAX), and XML), and the like. Herein, reference to a web interface encompasses one or more corresponding source files (which a browser may use to render the web interface) and vice versa, where appropriate.

In particular embodiments, the client application 110 may be an application operable to provide various computing functionalities, services, and/or resources, and to send data to and receive data from the other entities of the network 106, such as the connection network platform 112. For example, the client application 110 may be a client connection network application tightly integrated with the connection network platform 112, a messaging application 118 for messaging with users 108 of a messaging network or system, a web browser application, an internet searching application, and so forth.

In particular embodiments, the client application 110 may be storable in a memory and executable by a processor circuitry of the client device 104 to render user interfaces, receive user input, send data to and receive data from the connection network platform 112. The client application 110 may generate and present user interfaces to a user via an electronic display of the client device 104. For example, the client application 110 may generate and present a GUI 136 based at least in part on information received from the server device 102, the connection network platform 112, and/or another device or system (e.g., a third party server) via the network 106.

The connection network system 100 comprises a network 106. This disclosure contemplates any suitable network 106. As an example and not by way of limitation, one or more portions of a network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A single network 106 may comprise multiple networks 106.

In operation, a user 108 interacts with a client application 110 of the client device 104 to access applications and services provided by a connection network platform 112 of the server device 102 via one or more links 144 of the network 106. The links 144 may connect each client device 104 to the connection network platform 112 via the network 106. This disclosure contemplates any suitable link 144. In particular embodiments, one or more links 144 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 144 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 144, or a combination of two or more such links 144. Links 144 need not necessarily operate at the same throughout. One or more first links 144 may differ in one or more respects from one or more second links 144.

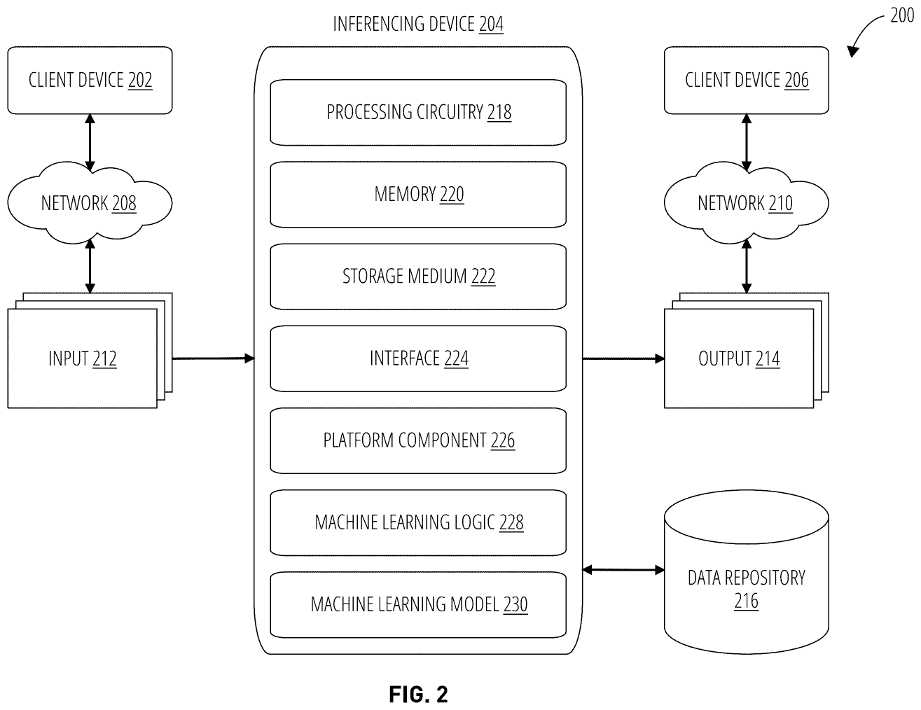

FIG. 2 illustrates an embodiment of a system 200. The system 200 is suitable for implementing one or more embodiments as described herein. In one embodiment, for example, the system 200 is an AI/ML system suitable for implementing models described with reference to any of the preceding description.

The system 200 comprises a set of M devices, where M is any positive integer. FIG. 2 depicts three devices (M=3), including a client device 202, an inferencing device 204, and a client device 206. The inferencing device 204 communicates information with the client device 202 and the client device 206 over a network 208 and a network 210, respectively. The information may include input 212 from the client device 202 and output 214 to the client device 206, or vice-versa. In one alternative, the input 212 and the output 214 are communicated between the same client device 202 or client device 206. In another alternative, the input 212 and the output 214 are stored in a data repository 216. In yet another alternative, the input 212 and the output 214 are communicated via a platform component 226 of the inferencing device 204, such as an input/output (I/O) device (e.g., a touchscreen, a microphone, a speaker, etc.).

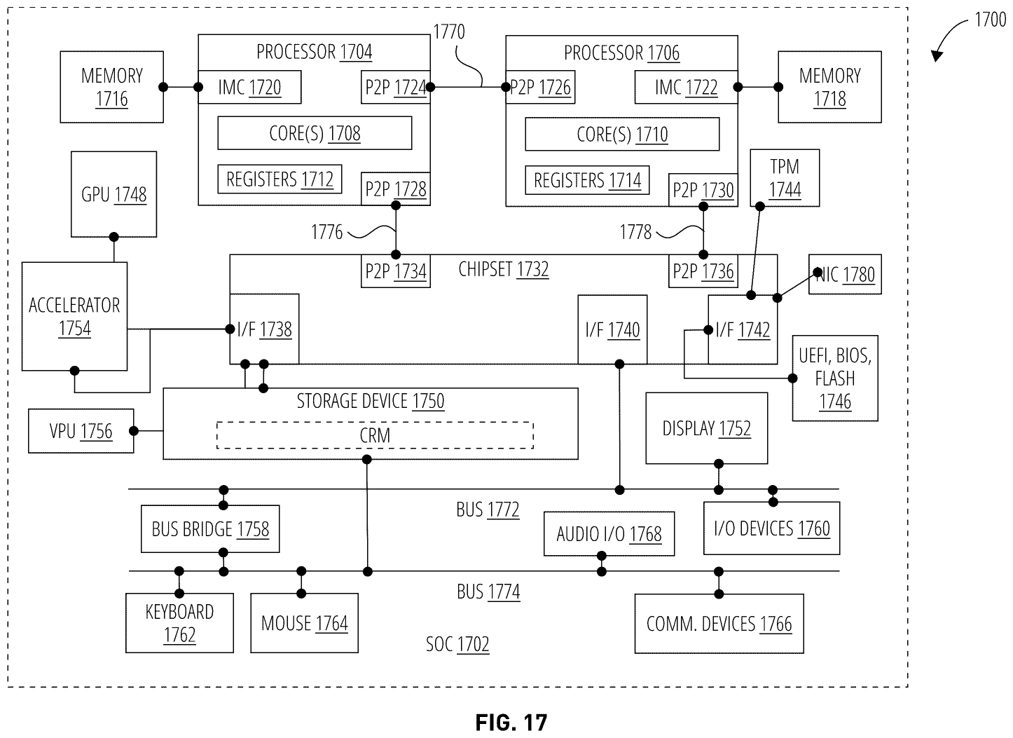

As depicted in FIG. 2, the inferencing device 204 includes processing circuitry 218, a memory 220, a storage medium 222, an interface 224, a platform component 226, ML logic 228, and an ML model 230. In some implementations, the inferencing device 204 includes other components or devices as well. Examples for software elements and hardware elements of the inferencing device 204 are described in more detail with reference to a computing architecture 1700 as depicted in FIG. 17. Embodiments are not limited to these examples.

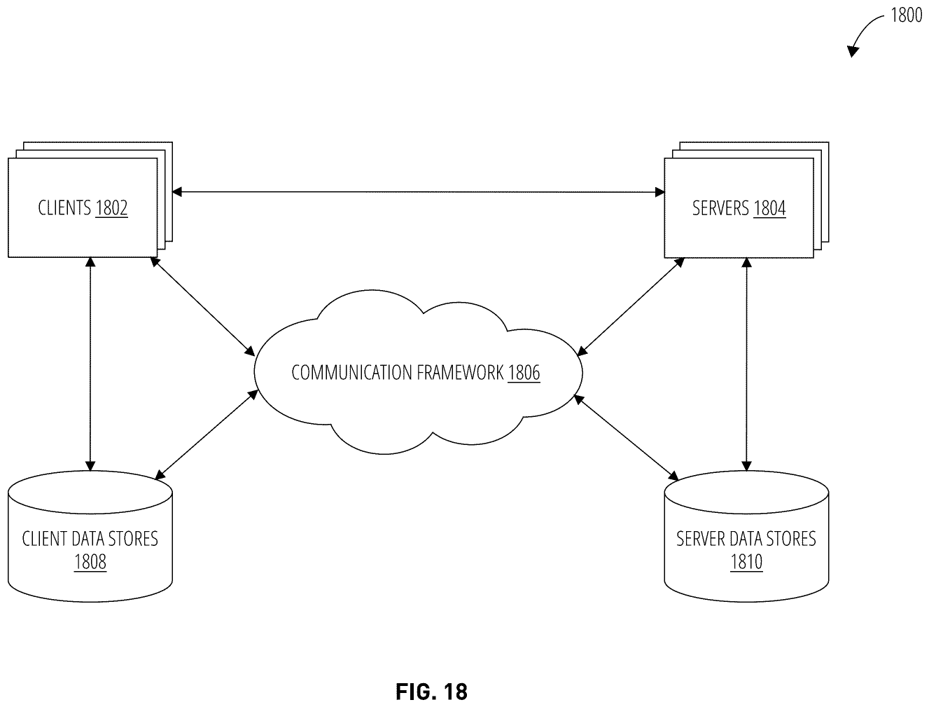

The inferencing device 204 is generally arranged to receive an input 212, process the input 212 via one or more AI/ML techniques, and send an output 214. The inferencing device 204 receives the input 212 from the client device 202 via the network 208, the client device 206 via the network 210, the platform component 226 (e.g., a touchscreen as a text command or microphone as a voice command), the memory 220, the storage medium 222 or the data repository 216. The inferencing device 204 sends the output 214 to the client device 202 via the network 208, the client device 206 via the network 210, the platform component 226 (e.g., a touchscreen to present text, graphic or video information or speaker to reproduce audio information), the memory 220, the storage medium 222 or the data repository 216. Examples for the software elements and hardware elements of the network 208 and the network 210 are described in more detail with reference to a communications architecture 1800 as depicted in FIG. 18. Embodiments are not limited to these examples.

The inferencing device 204 includes ML logic 228 and an ML model 230 to implement various AI/ML techniques for various AI/ML tasks. The ML logic 228 receives the input 212, and processes the input 212 using the ML model 230. The ML model 230 performs inferencing operations to generate an inference for a specific task from the input 212. In some cases, the inference is part of the output 214. The output 214 is used by the client device 202, the inferencing device 204, or the client device 206 to perform subsequent actions in response to the output 214.

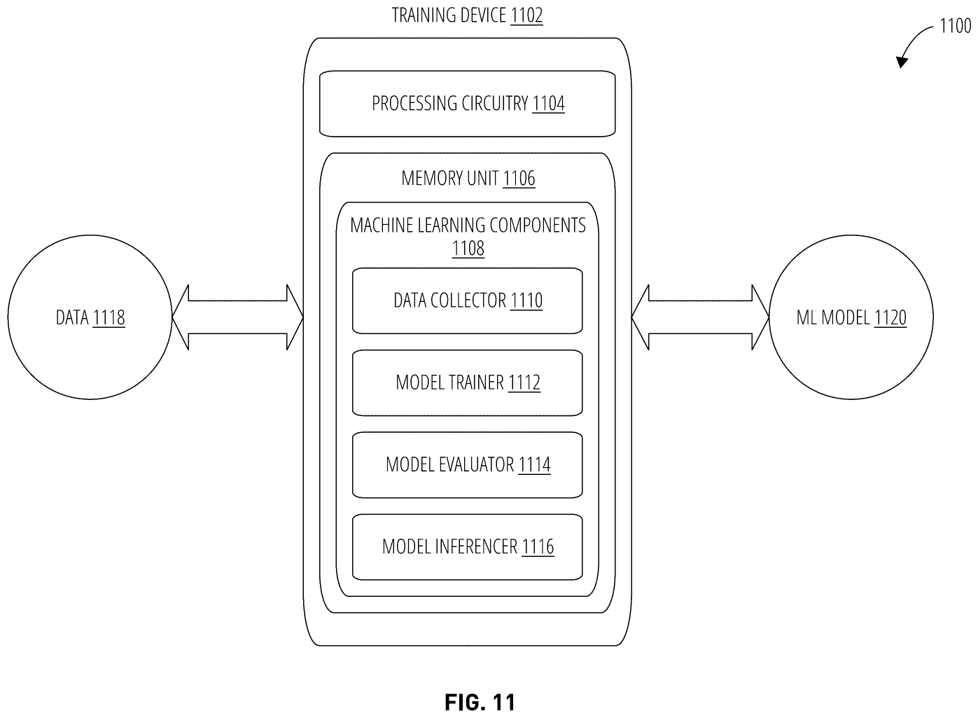

In various embodiments, the ML model 230 is a trained ML model 230 using a set of training operations. An example of training operations to train the ML model 230 is described with reference to FIG. 11.

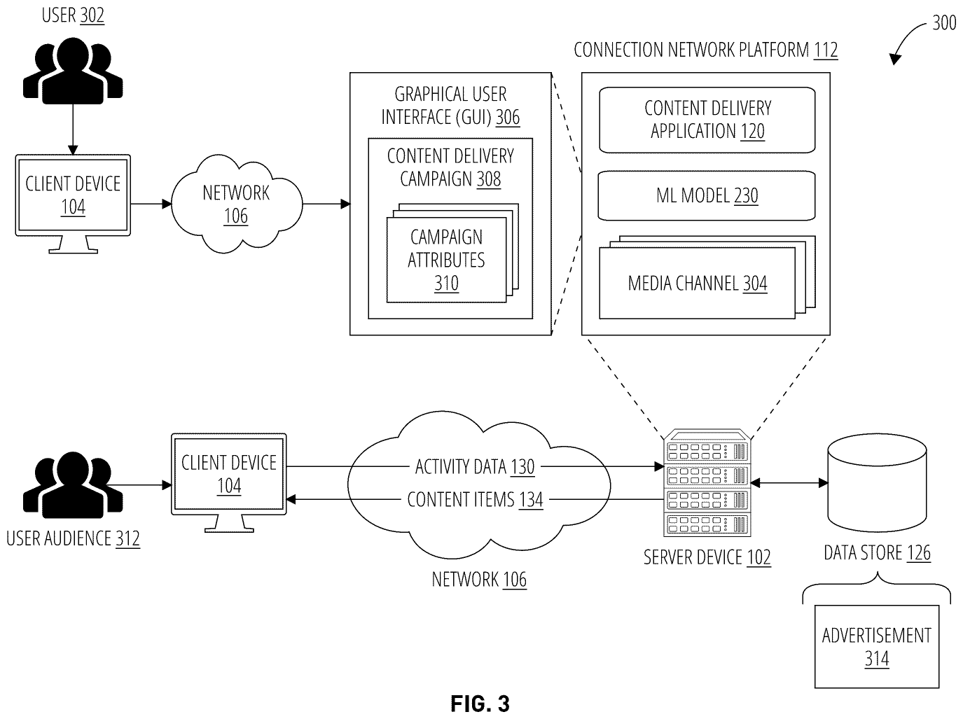

FIG. 3 illustrates a content delivery system 300. The content delivery system 300 is an example of a system designed to deliver one or more content items 134 such as one or more advertisements 314 to a user audience 312 of one or more users 108 of the connection network platform 112 of the connection network system 100. The content delivery system 300 delivers the advertisements 314 in a targeted manner. The content items 134 may comprise, for example, recommendations, advertisements, content, messages, suggestions, hyperlinks, files, job postings, articles, and any other content offered by the connection network platform 112 of the connection network system 100.

In various embodiments, the connection network system 100 may use the content delivery system 300 to provide a content delivery service via a content delivery application 120 (e.g., software as a service (SaaS)) to its users 108 (e.g., individuals, members, entities, groups, etc.). The content delivery system 300 is generally designed to deliver electronic content items 134 to users 108 based, at least in part, on user data 128 and activity data 130 of users 108 of the connection network system 100. In particular, the content delivery system 300 may deliver content items 134 such as advertisements 314 specifically targeted to an audience of users 108 based on user data 128 or activity data 130. For instance, a content producer such as an advertiser may create a content delivery campaign such as a marketing campaign or advertising campaign to deliver a series of advertisements 314 for a product or service of a business entity to an audience of users 108 of the connection network system 100 over a defined time interval (e.g., weeks, days, months, etc.).

The content delivery system 300 comprises a set of one or more client devices 104, server devices 102, and data stores 126. A client device 104 and a server device 102 may communicate information via a network 106. The client device 104 may comprise an electronic device, such as a smartwatch, smartphone, tablet, laptop computer, desktop computer, and so forth. The server device 102 may be implemented as a server in a data center, such as a cloud computing system or edge computing system. The client device 104 and the server device 102 may be implemented using an architecture as described in FIG. 17. The network 106 may be implemented using an architecture as described in FIG. 18. Embodiments are not limited to these example implementations.

The server device 102 implements a connection network platform 112 as described with reference to FIG. 1. In one embodiment, the connection network platform 112 includes at least one processor circuitry, at least one memory unit operably coupled to the processor circuitry, the memory unit including instructions executable by the at least one processor circuitry, and an ML model 230 comprising parameters and/or hyperparameters stored in the at least one memory unit. In one embodiment, for example, the ML model 230 is implemented as a two-tower ML model for an AI system implemented by the content delivery system 300 to offer a network service such as a content delivery service by the content delivery application 120 of the connection network platform 112. The content delivery application 120 may select one or more content items 134, such as advertisements 314, for delivery as targeted content over one or more media channels 304 to a client device 104. A user 108 from the user audience 312 may interact with a graphical user interface (GUI) to access the targeted content for presentation on the client device 104.

The server device 102 may include connection network platform 112 implementing a network service to user 108 of the connection network platform 112. Professional networking platforms offer a wide range of networking services to facilitate connections, career development, and knowledge sharing. Some examples of a network service offered by the connection network platform 112 include without limitation: (1) users can create a professional profile to showcase their skills, work experience, education, and professional accomplishments; (2) users can connect with colleagues, industry professionals, and potential employers to expand their professional network; (3) messaging capabilities for direct communication between users, facilitating professional conversations and networking opportunities; (4) users can join and participate in industry-specific groups and communities to engage in discussions, share insights, and network with like-minded professionals; (5) search job listings and recruiting tools for users to search for employment opportunities, apply for jobs, and connect with talent; (6) users can share industry-related content, articles, and professional updates to showcase expertise and engage with their network; and (7) access learning resources, courses, and training programs to support ongoing professional development and skill enhancement. These networking services are designed to help professionals connect, collaborate, and grow their careers. Embodiments are not limited to these examples.

In an example process, the connection network platform 112 obtains activity data 130 from users 108 via the client device 104. The users 108 interact with the connection network platform 112 via a user interface of the connection network platform 112. In some cases, portions of the user interface are displayed on a personal machine or client device 104 of a user 108. The activity data 130 represents various actions, activities or behaviors of one or more users 108 of the user audience 312. For example, activity data 130 may represent data collected as the users 108 interact with various content items 134, such as advertisement 314, of the data store 126 served via the server device 102. In another example, the activity data 130 may represent data collected as the users 108 interact with other products or services offered by the connection network platform 112, such as searching for job postings, sending messages to users 108, recommending posts by users 108, sending and responding to connection requests, playing online games, and other activities organic to use of the connection network platform 112. Session data is any activity data 130 collected during a defined session time window, such as activity of the user over a 24 hour period or some other time interval. For example, a user 108 of the user audience 312 may interact with the client device 104 to communicate with the connection network platform 112 of one or more of the server devices 102 to access one or more content items 134 stored by the data store 126. The users 108 may perform various activities, such as browsing a web site, searching for a job posting, reading content, watching a streaming video, messaging other members, clicking on an GUI item, interacting with an advertisements, or engaging in electronic commerce. The session data, including the activity data 130, is transferred between the client device 104 and the server device 102.

More particularly, the connection network platform 112 comprises the content delivery application 120, which includes or accesses an ML model 230 such as a two-tower ML model, and data for one or more media channels 304. The content delivery application 120 is responsible for delivery of targeted content based on activity data 130 and/or session data associated with the users 108 of the user audience 312. The content delivery application 120 uses the ML model 230 to support such activities. The content delivery application 120 then targets delivery of specific content items 134 to users within user segments, such as advertisements 314 for the user audience 312, over one or more media channels 304. The targeted content is a content item that is relevant to the user audience 312 or the user audience 312 segment, such as messages, predictions, recommendations, advertisements, or suggestions to improve user experience.

The targeted content is delivered through one or more of the media channels 304. A media channel refers to a specific platform or medium through which targeted content, such as advertisements, are disseminated to a target user. Media channels 304 can include various forms of digital and traditional media such as websites, mobile applications, social media platforms, television, radio, print publications, and outdoor advertising spaces. Each media channel possesses its own unique characteristics and user demographics, allowing advertisers to tailor their messages to reach the desired target user effectively. message provider, such as advertisers, often choose certain media channels based on factors such as user engagement, reach, cost, and the compatibility of the channel with their target market. An example of the media channel 304 is a social media platform or a professional media platform, or some other mode of information transfer within the platform.

The connection network platform 112 or components thereof are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) can also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a supercomputer, or any other suitable processing apparatus.

The data store 126 is an organized collection of data. For example, the data store 126 stores data in a specified format known as a schema. The data store 126 can be structured as a single database, a distributed database, multiple distributed databases, or an emergency backup database. In some cases, a database controller manages data storage and processing in data store 126. In some cases, a user interacts with the database controller. In other cases, the database controller operates automatically without user interaction. The data store 126 is configured to store various content items 134. The content items 134 include any multimedia information suitable for presentation by the client device 104, such as HTML code to present websites, text, images, video, messages, advertisements, and so forth. In addition, the data store 126 may also store application data comprising information and data used by the connection network platform 112. For example, data store 126 is configured to store user session data, profiles, embeddings, budgets, cached application programming interface (API) requests, machine learning model parameters, training data, and other data.

Network 106 facilitates the transfer of information between connection network platform 112, data store 126, and client device 104. Network 106 is a computer network configured to provide on-demand availability of computer system resources, such as data storage and computing power. In some examples, the network 106 provides resources without active management by the users 108. The network 106 includes data centers available to many users over the Internet. Some large cloud networks have functions distributed over multiple locations from central servers. A server is designated an edge server if it has a direct or close connection to a user 108. In some cases, a cloud is limited to a single organization. In other examples, the cloud is available to many organizations. In one example, the network 106 includes a multi-layer communications network comprising multiple edge routers and core routers. In another example, the network 106 is based on a local collection of switches in a single physical location.

In particular embodiments, the content delivery system 300 uses multiple ML models 230 to support an auto-targeting (AT) task and an audience expansion (AE) task for a content delivery campaign 308 on behalf of a content producer, such as an advertiser. For example, the content delivery system 300 may use an AT model for an AT task to select a seed audience for a content delivery campaign 308. The content delivery system 300 begins delivery of content items 134, such as advertisements 314, to users 108 of a user audience 312 (e.g., a seed audience). The content delivery system 300 collects activity data 130 of the users 108 of the user audience 312, such as user engagement with the advertisements 314 and other organic activities of users 108 as they interact with various products and services offered by the connection network platform 112, among other types of activity data 130. The content delivery system 300 uses an AE model for an AE task that periodically, aperiodically or continuously modifies the user audience 312 (e.g., adding or removing users) based on the collected activity data 130 to improve future user engagement with the advertisement 314. The AE model performs the AE task in an iterative manner until the content delivery system 300 identifies a user audience 312 comprising a performant audience (PA) segment for the content delivery campaign 308.

A PA segment for a content delivery campaign 308 such as an advertising campaign refers to a target group of individual users 108 who demonstrate high effectiveness in achieving campaign goals and objectives. These goals could include metrics such as conversions, click-through rates, engagement, or return on investment (ROI). In practical terms, a PA segment includes users 108 that are likely to engage with the advertisement 314 at a higher rate than the average audience, converts (e.g., makes a purchase, signs up for a service) more frequently, responds positively to the campaign call to action leading to measurable success, and/or aligns well with the product or service being advertised, showing a strong interest or need. Identifying and targeting a PA segment often involves analyzing data from past campaigns, using machine learning models to predict which segments are likely to perform well, and continuously optimizing the audience selection to improve campaign outcomes.

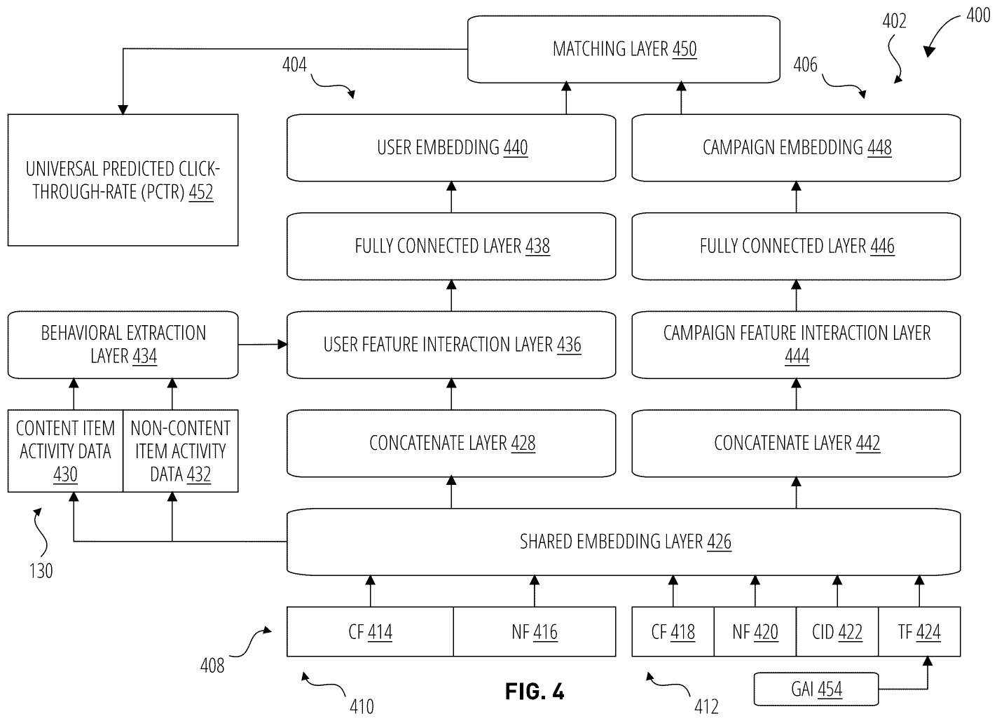

FIG. 4 illustrates an ML architecture 400. The ML architecture 400 is an example of a ML architecture or framework suitable for use as ML model 230 for the connection network platform 112 of the content delivery system 300. The ML model 230 is designed to support selection of users 108 for a PA segment of a content delivery campaign 308 suitable for delivery of advertisements 314 to electronic devices of the users 108 by the content delivery system 300. In one embodiment, for example, the ML model 230 is an EBR model. Embodiments are not limited to this example.

As depicted in FIG. 4, the ML architecture 400 illustrates an example of a multi-tower ML model, such as a two-tower ML model 402, that receives as input an input vector 408, analyzes the input vector 408, and it generates a metric such as a predicted click-through-rate (pCTR) for a candidate user 108 suitable for addition to, or subtraction from, a user audience 312 suitable for a content delivery campaign 308 managed by the content delivery system 300. The two-tower ML model 402 comprises a first tower 404 and a second tower 406. The first tower 404 is designed to process a first vector 410 of an input vector 408 to generate a user embedding 440. The second tower 406 is designed to process a second vector 412 of the input vector 408 to generate a campaign embedding 448. A matching layer 450 generates similarity scores for the user embedding 440 and the campaign embedding 448 using a similarity measure, such as cosine similarity. The matching layer 450 ranks and outputs a universal pCTR metric 452 for a user 108 based on the similarity measure. It may be appreciated that although certain embodiments implement a two-tower ML model 402, some embodiments may use an ML model with a single tower or more than two towers as needed for a given implementation. Embodiments are not limited to this two-tower example.

In a particular embodiment, the two-tower ML model 402 receives an input vector 408 comprising a first vector 410 and a second vector 412 by a two-tower ML model 402 for a content delivery system 300 of a connection network system 100. The first vector 410 comprises user features representing user attributes and activity data 130 associated with users 108 of the connection network system 100. The second vector 412 comprises campaign features representing a content delivery campaign 308. The campaign features may include, among other campaign features, a textual description of a content delivery campaign 308 managed by the content delivery system 300, denoted as textual features 424 of the second vector 412.

The two-tower ML model 402 generates multiple embeddings from the input vector 408. The two-tower ML model 402 generates a set of one or more user embeddings 440 from the first vector 410 by a first tower 404 of the two-tower ML model 402 based on the activity data 130 associated with users 108 of the connection network system 100. The activity data 130 represents content item activity data 430 and non-content item activity data 432. The two-tower ML model 402 also generates a set of one or more campaign embeddings 448 from the second vector 412 of the input vector 408 by a second tower 406 of the two-tower ML model 402 based on, at least in part, the textual description of the content delivery campaign 308.

A matching layer 450 of the two-tower ML model 402 generates a universal predicted click-through-rate (pCTR) metric, such as universal pCTR metric 452, based on a subset of the user embeddings 440 and a subset of the campaign embeddings 448. The universal pCTR metric 452 represents a probability of an interaction between a user identifier (ID) associated with a user 108 and a content item from the content items 134 associated with the content delivery campaign 308. The content delivery application 120 selects audience user identifiers associated with users 108 from a pool of user identifiers based on the universal pCTR metric 452. The audience user identifiers represent users 108 that are relevant to the content delivery campaign 308 to form an audience of users 108 for the content delivery campaign 308, such as user audience 312. The content delivery application 120 selects and sends one or more targeted content items 134 for the content delivery campaign 308 to electronic devices, such as client device 104, associated with the selected audience user identifiers of the user audience 312.

More particularly, a shared embedding layer 426 of the two-tower ML model 402 receives as input an input vector 408. An input vector in a machine learning model is a structured array of data that represents a single instance or observation. Each element in this vector corresponds to a particular feature or attribute of the instance, collectively providing a complete description that the model can process. The features can be numerical, categorical (often encoded into numerical form), or even binary, depending on the nature of the data and model requirements. Before being used in the model, these vectors typically undergo preprocessing steps like normalization or encoding to ensure they are in a suitable format. The structure of the input vector must align with what the model expects, as mismatches can lead to errors or suboptimal performance. In practice, multiple input vectors are often processed together in batches for efficiency, especially in models like neural networks. For example, in a model predicting house prices, an input vector might include data such as square footage, the number of bedrooms, and the age of the house, which the model then uses to make its prediction.

The input vector 408 comprises two parts denoted as a first vector 410 and a second vector 412. The first vector 410 comprises data for user-side features (or member-side features) such as categorical features 414 and numerical features 416 representing user-side features for a user 108, such as user data 128 and activity data 130 for the user 108. The second vector 412 comprises campaign-side features, such as categorical features 418, numerical features 420, a campaign ID 422, and textual features 424.

In one embodiment, for example, the textual features 424 for the second vector 412 are generated by a separate ML model 230, such as a generative AI (GAI) model denoted as GAI 454. The GAI 454 is designed to create new data samples that resemble a given dataset. Non-limiting examples of GAI 454 include generative adversarial networks (GANs), variational autoencoders (VAEs), transformers in Natural Language Processing (NLP) such as large language models (LLM) like generative pre-trained transformer (GPT) designed to generate human-like text based on a given prompt, diffusion models, autoregressive models, and so forth. In various embodiments, for example, the GAI 454 may be implemented as a transformer model such as a large language model (LLM) like a Bidirectional Encoder Representations from Transformers (BERT) model, Lightweight BERT (LIBERT) model, or a Lightweight Decoding-Enhanced BERT with Disentangled Attention (LiDeBERT) model. The GAI 454 is feed as input information about a content delivery campaign 308, such as one or more campaign attributes 310, and it performs creative content generation with a description for the content delivery campaign 308 in text form. The textual features 424 are derived from the output of the GAI 454.

The input vector 408 is fed into a shared embedding layer 426. An embedding layer in a neural network is a technique used to convert categorical data, such as words or items, into continuous vectors in a lower-dimensional space. This layer is particularly common in natural language processing (NLP) tasks, where it transforms words into dense vectors that capture semantic relationships between them. The embedding layer learns these representations during training, allowing the model to understand and work with complex, high-dimensional categorical data in a more efficient and meaningful way. This approach improves a model's ability to capture similarities and relationships within the data, leading to better performance on tasks like text classification, translation, and sentiment analysis. The shared embedding layer 426 is used in the two-tower ML model 402 to create a common representation for the first vector 410 and the second vector 412 of the input vector 408 that share similar characteristics, such as words or entities, across different contexts. By using the same embedding layer for multiple inputs, the two-tower ML model 402 can learn consistent and meaningful representations that capture relationships across the different inputs, regardless of their specific context. This approach is particularly useful in tasks like multi-modal learning or when working with multiple sequences that need to be understood in a unified way, enabling the model to generalize better and reduce the need for redundant parameters.

The first tower 404 receives as input a shared embedding that is output from the shared embedding layer 426. A concatenate layer 428 of the first tower 404 concatenates shared embeddings, and it outputs a concatenated embedding. In addition, the shared embedding is input to a behavioral extraction layer 434. The behavioral extraction layer 434 extracts behavioral pattern features from content item activity data 430 and non-content item activity data 432 from the shared embedding. The content item activity data 430 represents interactions between a user identifier for a user 108 and a content item of the content items 134 from the content delivery campaign 308. Non-limiting examples of content items 134 may comprise online advertisements from a sequential or non-sequential list of advertisements associated with a content delivery campaign 308. The non-content item activity data 432 may comprise organic content activity data that represents organic activities of a user 108, such as interactions between a user 108 and various organic content presented on a website of the connection network platform 112, such as products and/or services offered by the connection network platform 112 of the connection network system 100. Non-limiting examples of organic content include infrastructure elements or supporting elements that enable or support the delivery of content but are not considered content (e.g., backend code, database structures, metadata, etc.), functional elements or structural components that contribute to website functionality or layout (e.g., navigation menus, footers, buttons, sidebars, forms, etc.), GUI elements that include all the interactive and design aspects that help users interact with content items, or user generated content. Non-limiting examples of user generated content may include professional profiles with detailed information about users of the connection network system (e.g., work experience, skills, and endorsements), articles or posts created by users and industry leaders covering various topics (e.g., business, technology, and career advice), online courses and tutorials on a wide range of professional skills and subjects, company profiles offering insights about a company (e.g., company culture, job openings, and industry news), connections and networking tools to connect with and recommend other professionals, forums and discussion groups where users can share ideas and discuss industry trends, and other types of content designed to facilitate professional growth and industry engagement. Embodiments are not limited to these examples.

The behavioral extraction layer 434 is a specialized component that captures and analyzes user behavior to infer preferences and interests. The behavioral extraction layer 434 uses data from both content item activity data 430 such as advertising activities (e.g., clicks on ads, engagement with promoted content, etc.) and non-content item activity data 432 such as organic activities of a user 108 interacting with the connection network platform 112 (e.g., profile views, connections, post interactions, etc.) to build a comprehensive profile of user preferences. The content item activity data 430 includes any interaction a user 108 has with ads, such as clicks, time spent on ad content, conversions, etc. The non-content item activity data 432 includes organic activities such as non-ad-based activities like viewing job postings, interacting with professional content, sending messages, making connections, and profile updates. The behavioral extraction layer 434 extracts features from both types of activities, such as frequency of interactions, types of content engaged with, keywords associated with the activities, and behavioral patterns over time. For example, if a user 108 frequently engages with ads related to data science and also organically interacts with content about AI research, the layer would capture this as a preference for data science and AI. The behavioral extraction layer 434 analyzes these extracted features to infer user preferences or behavior. For instance, it might identify that a user is interested in career development if they engage with content about skill-building and frequently interact with ads promoting courses. This inference could involve techniques like clustering, classification, or neural networks to categorize user preferences. The behavioral preference behavioral extraction layer 434 integrates with the broader recommendation or personalization system within the connection network platform 112. This allows the platform to tailor content, job recommendations, and ads based on the inferred preferences, making the user experience more relevant. In some implementations, the system could incorporate a feedback loop, where the effectiveness of content and ad recommendations is monitored and used to refine the preference extraction process.

For example, assume a user 108 interacts with connection network platform 112 such as frequently clicking on ads for leadership courses and also engages with content related to team management. The behavioral preference behavioral extraction layer 434 would combine these signals to infer that the user 108 is interested in leadership development. Consequently, the content delivery system 300 might prioritize showing them related job opportunities, relevant content, and more targeted ads. The behavioral extraction layer 434 helps create a more personalized and relevant user experience by leveraging both advertising and organic activities to understand and predict user preferences more accurately.

A user feature interaction layer 436 receives as input behavioral pattern features from the behavioral extraction layer 434 and the concatenated embedding from the concatenate layer 428. The user feature interaction layer 436 encodes a set of user interaction features based on the behavioral pattern features and the concatenated embedding. The user feature interaction layer 436 is another specialized component that captures and models the interactions between various features related to a user activities, profile attributes, and engagement patterns. The goal of this layer is to better understand how different features or attributes of a user 108 interact with one another to influence outcomes such as content recommendations, job matches, or social connections. The user feature interaction layer 436 encodes various user-related data points (features) into a format suitable for machine learning. These features could include user data 128 for a user 108 such as profile information (e.g., job title, industry, location), activity data 130 of the user 108 (e.g., likes, shares, comments, searches), and network data (e.g., connections, groups). The user feature interaction layer 436 models how different features interact with each other. For example, the user feature interaction layer 436 may determine a relationship between profile and activity interaction, such as a job title for a user 108 and a type of content items 134 with which the user 108 interacts. The user feature interaction layer 436 may determine a relationship between network and engagement interaction, such as a size or composition of a user's network impact a user 108 engagement with content. The user feature interaction layer 436 may determine a relationship between demographics and behavior interaction, such as how do demographic factors like location or industry interact with behavioral data like search history or content sharing. The user feature interaction layer 436 may create cross-feature terms or use advanced techniques like factorization machines or neural networks to capture non-linear interactions between features. Since interactions can exponentially increase the number of features, the user feature interaction layer 436 often includes techniques to reduce dimensionality while preserving important interactions. For example, the user feature interaction layer 436 may implement Principal Component Analysis (PCA) or embedding layers in neural networks.

For example, assume a user 108 is a software engineer with a history of engaging with AI-related content and is connected to a significant number of AI professionals. The user feature interaction layer 436 would model the interaction between their job title, content engagement, and network connections to better understand their professional focus. This insight could then be used to recommend relevant job postings in AI, suggest connections with key AI influencers, or surface related articles and courses. In this way, the user feature interaction layer 436 enhances the ability to make personalized and relevant predictions by capturing the nuanced relationships between various user attributes and activities.

A fully connected layer 438 receives as input the user interaction features, and it generating the user embedding 440 based on the user interaction features. The fully connected layer 438 generates a user embedding 440 for the set of user embeddings 440 based on the user interaction features identified by the user feature interaction layer 436. The fully connected layer 438 comprises a set of neurons using an activation function, such as a hyperbolic tangent (tanh), for example. More particularly, the fully connected layer 438 in the first tower 404 is a specialized component that connects every neuron from a previous layer to every neuron in a current layer. When used to generate a user embedding 440, this layer takes a high-dimensional input, such as user interaction features describing a user's profile, activity, and preferences, and transforms it into a lower-dimensional vector that encapsulates the user's key characteristics. This embedding serves as a condensed representation of the user 108, capturing the essential patterns and relationships between different features in a way that the model can use for tasks like recommendations, personalization, or predictions. By learning these embeddings through training, the neural network can effectively encode complex user data 128 and activity data 130 into meaningful and compact vectors that can be leveraged across various applications within the system.

Similar to the first tower 404 of the two-tower ML model 402, the second tower 406 also includes a concatenate layer 442 and a fully connected layer 446. The concatenate layer 442 and the fully connected layer 446 of the second tower 406 operate in a same or similar manner as described for the concatenate layer 428 and the fully connected layer 438 of the first tower 404. In addition, the second tower 406 comprise a campaign feature interaction layer 444. The user feature interaction layer 436 models user behavioral patterns based on user data 128 and activity data 130, such as content item activity data 430 and non-content item activity data 432, to infer user interaction features. Similarly, the campaign feature interaction layer 444 models campaign patterns based on campaign attributes 310 and activity data 130 representing interactions between users 108 and content items 134 such as advertisement 314 delivered by a content delivery campaign 308. The concatenate layer 442, the campaign feature interaction layer 444, and the fully connected layer 446 of the second tower 406 represent the processing stages for generating a campaign embedding 448 for a set of campaign embeddings 448 for a given content delivery campaign 308.

A matching layer 450 receives as input the user embedding 440 and the campaign embedding 448 from the first tower 404 and the second tower 406, respectively, and it performs a matching function to match the user embedding 440 and the campaign embedding 448 to determine a universal pCTR metric 452 for a user 108. The matching layer 450 matches one or more user embeddings 440 with one or more campaign embeddings 448 using a similarity measure to form a set of matched embeddings, and it generates a universal pCTR metric 452 based on the matched embeddings. A matching function in machine learning is designed to compare embeddings, which are compact, vectorized representations of data points, using a similarity measure. The purpose of this function is to assess how closely two embeddings align with one another, typically in tasks like recommendation, search, or classification. Common similarity measures include cosine similarity, Euclidean distance, or dot product, which quantify the degree of resemblance between the vectors. The matching function then uses this measure to determine the best match between embeddings, effectively linking similar items, users, or features based on their underlying patterns as captured by the embeddings. The matching layer 450 uses a similarity measure, such as cosine similarity, to quantify a degree of resemblance between the user embedding 440 of a user 108 and the campaign embedding 448 of a content delivery campaign 308. A higher degree of similarity indicates a higher probability that the user 108 would be interested in advertisements 314 associated with the content delivery campaign 308 and delivered by the content delivery system 300.

The two-tower ML model 402 may be trained by a training device on a training dataset of training datapoints. Once trained, the two-tower ML model 402 may perform inferencing operations on new datapoints to support the content delivery application 120 of the content delivery system 300. In one embodiment, for example, the two-tower ML model 402 may be trained using a training dataset comprising one or more training datapoints. For example, the training datapoints may comprise pseudo-labels derived from click actions on a web page, such as a landing page, of a GUI 136 of the connection network platform 112 of the connection network system 100. In another example, the training datapoints may comprise chargeable clicks on a web page of a GUI 136 of the connection network platform 112 of the connection network system 100. Embodiments are not limited to these examples. A training device and training operations for the two-tower ML model 402 are described in more detail with reference to FIG. 11.

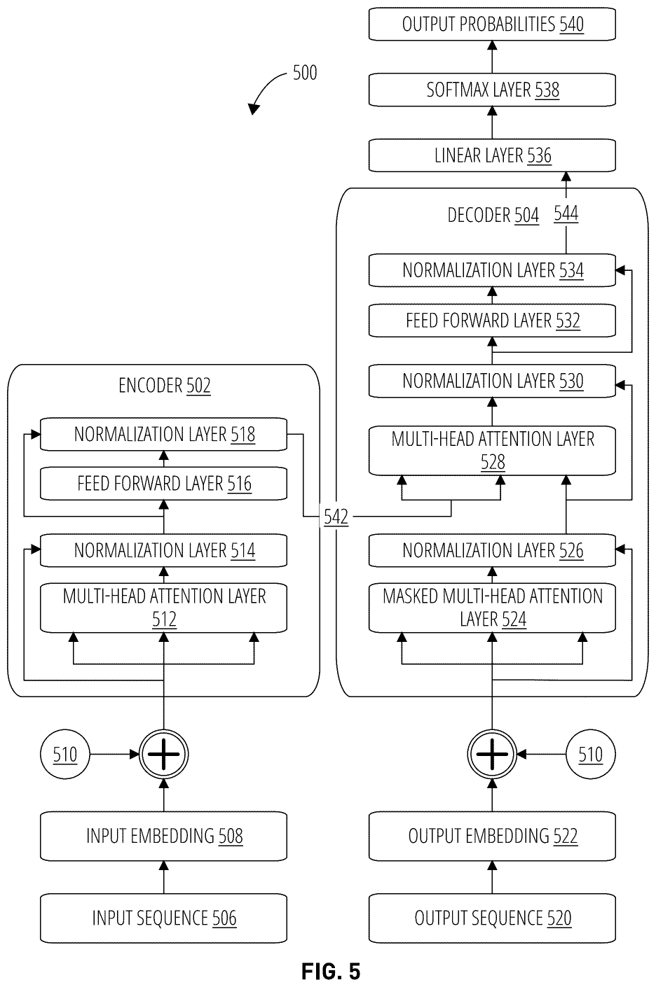

FIG. 5 illustrates a transformer model 500. The transformer model 500 is an example of a transformer architecture suitable for use by the GAI 454 of the two-tower ML model 402 of the ML architecture 400. In particular, the transformer model 500 is an example of a transformer architecture suitable for GPT, such as a version of ChatGPT. ChatGPT is trained on massive amounts of data, allowing it to generate text and respond to various prompts with human-like precision and accuracy. Embodiments are not limited to transformers.

As depicted in FIG. 5, the transformer model 500 comprises an encoder 502 and a decoder 504. The encoder 502 receives as input an input sequence 506, which is converted to an input embedding 508. A positional encoding 510 is added to the input embedding 508. The input embedding 508 with positional encoding 510 is input to the encoder 502. The encoder 502 comprises a multi-head attention layer 512, a normalization layer 514, a feed forward layer 516, and a normalization layer 518. The encoder 502 outputs an encoder output 542 to the decoder 504. The decoder 504 receives as input an output sequence 520, which is converted to an output embedding 522. A positional encoding 510 is added to the output embedding 522. The output embedding 522 with positional encoding 510 is input to the decoder 504. The decoder 504 comprises a masked multi-head attention layer 524, a normalization layer 526, a multi-head attention layer 528, a normalization layer 530, a feed forward layer 532, and a normalization layer 534.

Specifically, the encoder 502 is a neural sequence transduction model comprising an encoder 502 and a decoder 504. The encoder 502 receives an input sequence 506 and it translates the input sequence 506 into a lower-dimensional space. The encoder 502 maps an input sequence of symbol representations (x₁, . . . , xₙ) to a sequence of continuous representations z=(z₁, . . . , Zₙ). Given z, the decoder 504 then generates an output sequence (y₁, . . . , yₘ) of symbols one element at a time. At each step, the model is auto-regressive, consuming the previously generated symbols as additional input when generating the next. The decoder 504 translates the lower-dimensional data provided by the encoder 502 back to the original data format. Both the encoder 502 and the decoder 504 share three main types of layers, including a positional encoding layer, self-attention layer, and feedforward layer.

The encoder 502 transforms natural language input into numerical vectors. The encoder 502 receives an input sequence 506. The input sequence is a sequence of tokens (e.g., words or sub-words) that represent the text input. An input encoding layer of the encoder 502 converts the input sequence 506 into an input embedding 508. An input embedding 508 is a numerical representation of concepts converted to number sequences. The input embedding 508 is an NLP technique that represents words with vectors in such a way that once represented in a vectorial space, the mathematical distance between vectors is representative of the similarity among words they represent. For example, the content delivery application 120 may incorporate input embeddings to personalize, recommend, and search content. The input embedding 508 may comprise a matrix of vectors, where each vector represents a token in the sequence. The input embedding layer maps each token to a high-dimensional vector that captures the semantic meaning of the token.

Positional encoding 510 is a fixed, learned vector that represents a position of a word in the input sequence. It is added to the input embedding 508 so that the final representation of a word includes both its meaning and its position. Positional encoding is a technique used in transformer architectures, such as those employed by ChatGPT, to provide information about the relative positions of tokens in the input sequence. Since transformers do not inherently recognize the order of tokens due to their attention mechanism, positional encoding is crucial for enabling the model to consider sequence structure. To capture the order of the tokens in the input sequence, a positional encoding is added to the input embedding 508. The positional encoding is a vector that represents the position of each token in the sequence.

The encoder 502 includes multiple self-attention layers. The self-attention layers are responsible for determining the importance of each input token in generating the output. The self-attention layer allows the model to compute relationships between different parts of the input sequence 506. In order to obtain a self-attention vector for a sentence, the self-attention layer uses query, key, and value matrices. These matrices are used to calculate attention scores between the elements in the input sequence and are three weight matrices that are learned during the training process. In the query, key, and value computations, the input vectors are transformed into three different representations using linear transformations. In an attention computation operation, the model computes a weighted sum of the values, where the weights are based on the similarity between the query and key representations. The weighted sum represents the output of the self-attention mechanism for each position in the sequence.

The encoder 502 uses a multi-head attention layer 512. The multi-head attention layer 512 uses multiple self-attention layers operating in parallel on different parts of the input data, producing multiple representations. The multi-head attention layer 512 allows the model to focus on different parts of the input sequence and compute relationships between them in parallel. In each head, the query, key, and value computations are performed with different linear transformations, and the outputs are concatenated and transformed into a new representation. The output of the multi-head self-attention mechanism is fed into a feed forward layer 516.

The feed forward layer 516 comprises a series of fully connected layers and activation functions. The feed forward layer 516 transforms the output of the multi-head attention layer 512 into a suitable representation for the final output. The feed forward layer 516 is a fully connected layer, also known as a dense layer, where every neuron in the layer is connected to every neuron in the preceding layer. An activation function is a non-linear function that is applied to the output of the fully connected layer. The activation function introduces non-linearity into the output of a neuron, which allows the network to learn complex patterns and relationships in the input data. An example of an activation function is a rectified linear unit (ReLu). The output of the feed forward layer 516 is used as input to the next layer in the encoder 502.

The encoder 502 may also comprise a number of normalization layers, such as a normalization layer 514 and a normalization layer 518. The activations in each layer of the transformer architecture are normalized using layer normalization, which helps stabilize the training process and prevent the model from overfitting. A residual connection followed by layer normalization helps to stabilize the training process and make the model easier to train. The output of the normalization layer 518 is the final output from the encoder 502 and it is a vector representation of the input sequence 506. The final output from the normalization layer 518 is used as input to the multi-head attention layer 528 of the decoder 504.

The decoder 504 decodes the input sequence 506 to the original data format. Similar to the encoder 502, the decoder 504 shares the core elements of positional encoding, self-attention, and feedforward layers. As depicted in transformer model 500, the decoder 504 comprises a masked multi-head attention layer 524, a normalization layer 526, a multi-head attention layer 528, a normalization layer 530, a feed forward layer 532, and a normalization layer 534. The decoder 504 outputs a decoder output 544 to a linear layer 536. The linear layer 536 is a feedforward network that adapts the dimension of the input to the dimension of the output. The output of the linear layer 536 feeds into a softmax layer 538. The softmax layer 538 transforms the input into a vector of probabilities. The output of the softmax layer 538 is a set of an output probabilities 540 for the transformer model 500. The transformer model 500 then picks the word corresponding to the highest probability and uses it as a best output of the model.

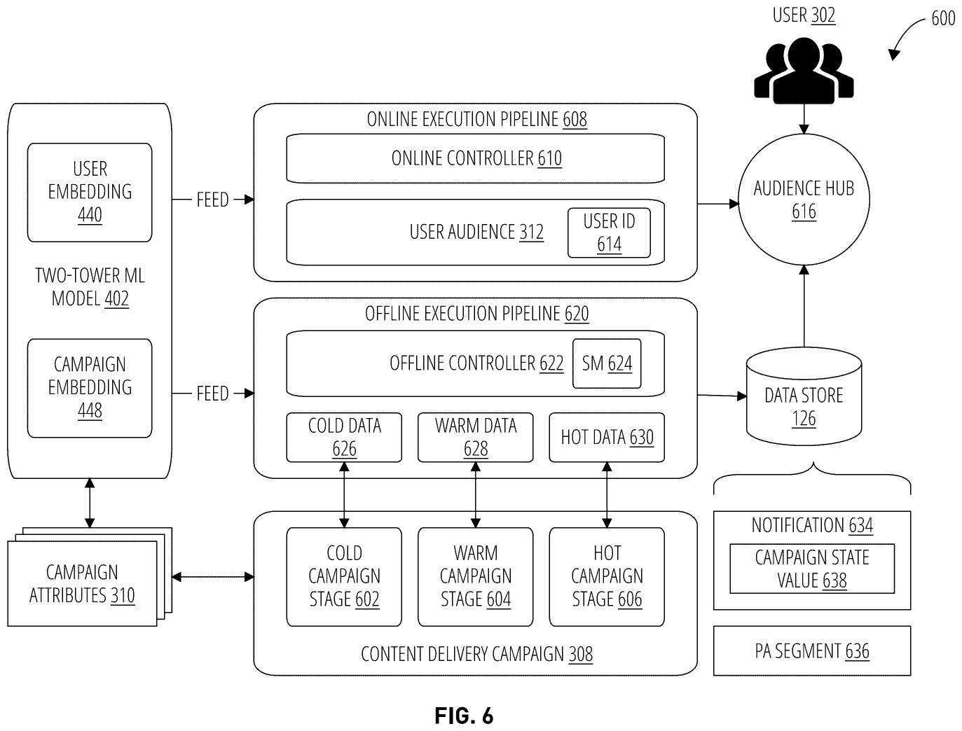

FIG. 6 illustrates a logic diagram 600. The logic diagram 600 is an example of a data flow for the content delivery system 300.

As previously described, the content delivery system 300 may implement one or more AT models and/or AE models to automatically identify users 108 of the connection network platform 112 suitable for addition to a user audience 312 and that are relevant to a content delivery campaign 308. In various embodiments, the AT and/or AE task is performed in discrete campaign stages. For example, the AT model and/or the AE model may operate in multiple campaign stages, where each campaign stage successively identifies an increasingly relevant audience of users 108 for the content delivery campaign 308, until the AE model converges on a user audience 312 comprising a final PA segment for the content delivery campaign 308.

In one embodiment, for example, the campaign stages for a content delivery campaign 308 may include a cold campaign stage 602, a warm campaign stage 604, and a hot campaign stage 606. In the cold campaign stage 602, an AT model and/or an AE model (e.g., two-tower ML model 402) may generate cold data 626 such as a seed audience of users 108. In the warm campaign stage 604, the AT model and/or an AE model may generate warm data 628 such as an intermediate audience of users 108 derived from the seed audience of users 108 and activity data 130 of users 108. In the hot campaign stage 606, the AT model and/or an AE model may generate hot data 630 derived from one or more intermediate audiences of users 108 and more activity data 130 of users 108. In one embodiment, for example, the hot data 630 may comprise a user audience 312 comprising a PA segment 636 of users 108 for the content delivery campaign 308.

In various embodiments, the content delivery system 300 implements the AT model and the AE model as embedding-based retrieval (EBR) models. Identifying a PA segment 636 from among millions or billions of users 108 of a connection network system 100 is a tedious and time consuming task. Therefore, the content delivery system 300 utilizes an AT model to automatically identify a seed audience and target user-ad relevance pairs. A by-product of the AT model are user embeddings 440 and campaign embeddings 448, which are applied in a downstream AE model to identify relevant user candidates for a PA segment 636 for a given content delivery campaign 308. In one embodiment, for example, the AE model may be implemented as an EBR model, such as a recurrent neural network (RNN) or a transformer. An EBR model is designed to make decisions or predictions based on data that is represented as a sequence of events that occur over time. For instance, in recommendation systems, each user interaction (e.g., clicks, purchases, etc.) can be treated as a discrete event. EBR focuses on representing and learning from these events to predict future events or outcomes. For example, an EBR model may be trained to receive as input various user features and campaign features, and it generates a universal pCTR metric 452 as output, as described with reference to FIG. 4 and FIG. 5. The universal pCTR metric 452 represents an estimate of the probability of a user clicking on an advertisement 314. The content delivery system 300 uses the universal pCTR metric 452 as one basis for selecting users 108 to add to a PA segment 636 for a given content delivery campaign 308 (e.g., a marketing campaign). This process ensures that a content delivery campaign 308 serves advertisements 314 that are relevant to users 108 of the connection network platform 112 within a PA segment 636, thereby optimizing advertisement placements.

In various embodiments, the content delivery system 300 utilizes multiple execution pipelines to support content delivery services. As previously described, efficiently finding relevant user candidates for marketing campaigns in a large audience pool is a technically difficult process. An EBR model executing on HPC platforms may take hours or even days to perform a downstream AE task to find a PA segment for a given marketing campaign. Meanwhile, an advertiser may desire to start actively delivering advertisements to a seed audience immediately upon launch of a new campaign, rather than waiting hours or days for an AE model to identify a complete PA segment for the new campaign. To better manage timing of content delivery for a new marketing campaign, the content delivery system uses multiple execution pipelines, such as an online execution pipeline 608 and an offline execution pipeline 620. The online execution pipeline 608 uses one or more EBR models for an AT task to identify seed audiences online and begins delivery of advertisements 314 to users of the seed audience. The offline execution pipeline 620 uses one or more EBR models to identify a PA segment 636 offline in the background. In this way, the content delivery system 300 can start immediate delivery of advertisements 314 to users 108 of the seed audience using the online execution pipeline 608, while the AE model continues iterating on the AE process to identify a PA segment 636 for the content delivery campaign 308 using the offline execution pipeline 620. The content delivery system 300 also uses a custom notification data structure to allow the offline execution pipeline to generate a notification 634 to notify the online execution pipeline 608 when certain outputs of the offline execution pipeline 620 are ready for execution by the online execution pipeline 608, such as the different audiences of users defined for the various campaign stages (e.g., cold state, warm state, hot state) of the content delivery campaign 308.

An online execution pipeline processes data in real-time or near-real-time, meaning it handles data as it is received or generated. This type of pipeline is designed to provide immediate feedback, often in systems requiring low-latency responses such as real-time analytics, online recommendation engines, or AI models that need to adapt to live input. Online execution pipelines continuously interact with external data sources, such as user inputs or sensor feeds, processing the incoming data dynamically to maintain up-to-date results. In contrast, an offline execution pipeline processes data in bulk at scheduled intervals, typically handling large volumes of pre-collected data rather than working in real-time. Feedback or results from an offline pipeline are not immediate; instead, they are provided after the entire batch of data has been processed. Offline execution pipelines are commonly used in scenarios where immediate feedback is unnecessary, such as in historical data analysis, large-scale batch processing, or training machine learning models with static datasets. Offline pipelines work with snapshots of data, offering more computational flexibility at the cost of real-time interaction.

As depicted in FIG. 6, the logic diagram 600 illustrates the two-tower ML model 402 operating in different execution pipelines of the content delivery system 300. In one embodiment, for example, a first version of the two-tower ML model 402 operates in an offline execution pipeline 620 and a second version of the two-tower ML model 402 operates in an online execution pipeline 608 of the content delivery system 300 of the connection network system 100. In one embodiment, for example, a single two-tower ML model 402 may feed user embeddings 440 and campaign embeddings 448 into both pipelines.

The online execution pipeline 608 receives as input the user embeddings 440 and the campaign embeddings 448 from the two-tower ML model 402. In various embodiments, the two-tower ML model 402 may be implemented as an AT EBR model, an AE EBR model, or a combination of both. The online execution pipeline 608 comprises an online controller 610 to control operations for the online execution pipeline 608. The online execution pipeline 608 serves advertisements 314 for a content delivery campaign 308 to a user audience 312 comprising one or more users 108 as represented by a set of user identifiers 614. A user 302, such as an advertiser, may control various campaign attributes 310 for the content delivery campaign 308 via an audience hub 616.

A content delivery campaign 308, such as an advertising campaign, is shaped by a variety of campaign attributes 310 that collectively determine its strategy, execution, and effectiveness. One of the primary considerations is the target audience, which includes factors like demographics, psychographics, and behavioral data. Understanding who the campaign is meant to reach is crucial, as it influences the messaging and channels used. Marketers often segment the audience into specific groups based on shared characteristics, ensuring that the campaign resonates with the right people. The objectives of the campaign play a central role in its design. Whether the goal is to increase brand awareness, drive conversions, encourage engagement, or retain existing customers, each objective requires a tailored approach. These goals guide decisions around ad creative, content, and the call to action, which prompts the audience to take specific actions, such as making a purchase or signing up for a service. Budget and bidding strategies are also critical components, as they determine the financial resources allocated to the campaign. This includes decisions on how much to spend overall, daily budget limits, and the bidding strategy, such as whether to prioritize cost-per-click, cost-per-impression, or cost-per-acquisition. These financial considerations are balanced against the campaign's goals to ensure an effective and efficient use of resources. The ad creative is another key attribute, encompassing the format, messaging, imagery, and overall design of the ads. Different ad variants may be developed for A/B testing or to appeal to different audience segments. The choice of channels and platforms is also important, as it influences where and how the ads are delivered to the target audience. Cross-channel integration ensures a cohesive campaign experience across multiple platforms and devices. Timing and schedule are crucial as well, determining when the campaign runs and at what times the ads are shown. This includes considerations of seasonality, ensuring that the campaign aligns with relevant trends or key dates. Meanwhile, measurement and analytics are used to track the campaign's performance, with key performance indicators (KPIs) like click-through rate, conversion rate, and return on ad spend providing insights into its success. Attribution models help assign credit for conversions to different touchpoints in the customer journey, while tracking mechanisms like pixels and UTM parameters provide the data needed for analysis. Audience targeting and segmentation further refine the campaign's focus, using custom audiences, lookalike audiences, or retargeting strategies to reach the most relevant users. Finally, compliance with legal requirements and platform-specific regulations ensures that the campaign adheres to necessary standards, protecting both the brand and its audience. All these campaign attributes 310 work together to create a well-rounded and effective advertising campaign, designed to meet specific objectives while engaging the intended audience in a meaningful way.

The offline execution pipeline 620 may operate sequentially or in parallel to the online execution pipeline 608. As the online execution pipeline 608 serves advertisements 314 to a user audience 312, the offline execution pipeline 620 engages in an AE task to periodically, aperiodically, or continuously select user identifiers 614 from the pool of user identifiers for the connection network platform 112 based on the universal pCTR metric 452 in multiple campaign stages of the content delivery campaign 308, the multiple campaign stages comprising a cold campaign stage 602, a warm campaign stage 604, and a hot campaign stage 606. Similar to the online controller 610, the offline controller 622 controls operations for the offline execution pipeline 620.

Specifically, the offline controller 622 controls operations for the offline execution pipeline 620 using a state machine 624 as it executes an AT task and AE task to identify sets of candidate users 108 suitable for inclusion in a user audience 312. The offline controller 622 (or a stage controller) of the offline execution pipeline 620 selects, in an iterative AE process, candidate user identifiers 614 from the pool of user identifiers 614 representing users 108 of the connection network platform 112. In various campaign stages, the offline controller 622 selects a first set of candidate user identifiers 614 (e.g., cold data 626) from the pool of user identifiers 614 based on the universal pCTR metric 452 in a cold campaign stage 602 of the content delivery campaign 308, selects a second set of candidate user identifiers 614 (e.g., warm data 628) from the pool of user identifiers 614 based on the universal pCTR metric 452 in a warm campaign stage 604 of the content delivery campaign 308, and selects a third set of candidate user identifiers 614 (e.g., hot data 630) from the pool of user identifiers 614 based on the universal pCTR metric 452 in a hot campaign stage 606 of the content delivery campaign 308. It may be appreciated that any number of campaign stages may be defined for a given content delivery campaign 308, and embodiments are not limited to three campaign stages.

The offline controller 622 generates a notification 634 having a campaign state value 638 representing a ready state for the cold campaign stage 602, the warm campaign stage 604, or the hot campaign stage 606 when the cold campaign stage 602, the warm campaign stage 604, or the hot campaign stage 606 is complete. The offline controller 622 stores the notification 634 with the campaign state value 638 in a data store 126. Additionally, or alternatively, the offline controller 622 stores the hot data 630 as a PA segment 636 for the content delivery campaign 308 in the data store 126.

The online execution pipeline 608 receives the notification 634, retrieves the campaign state value 638 and data for the user audience 312, and it serves advertisements 314 to the expanded user audience 312. This process continues until a PA segment 636 is identified and ready for serving of targeted advertisements 314 by the online controller 610 of the online execution pipeline 608.

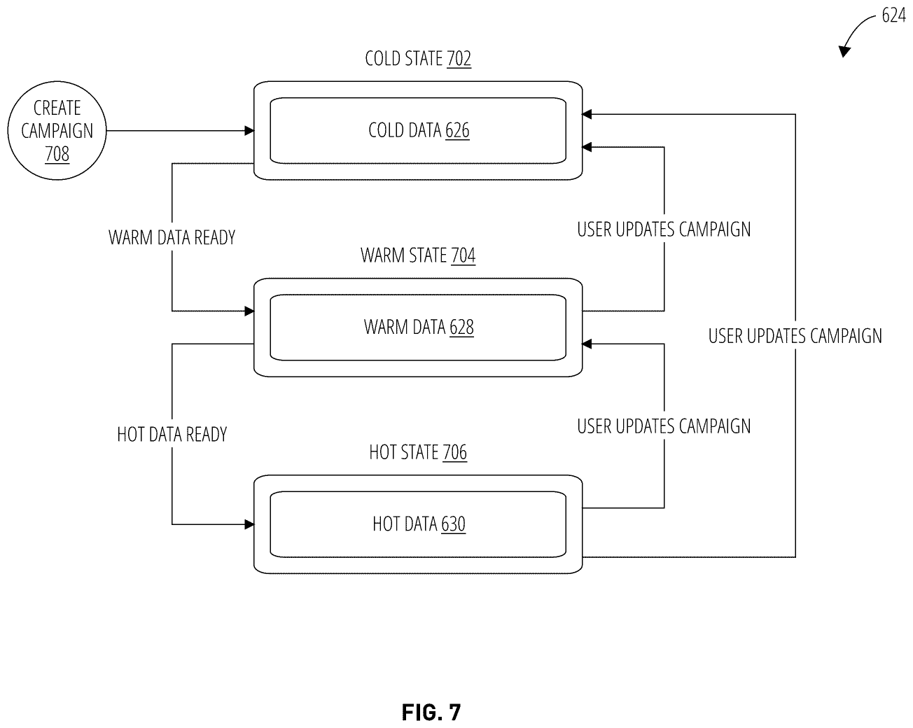

FIG. 7 illustrates an example of a state machine 624 suitable for use by the offline controller 622 of the offline execution pipeline 620. Embodiments are not limited to this example.

As previously described with reference to FIG. 6, the campaign stages for a content delivery campaign 308 may include a cold campaign stage 602, a warm campaign stage 604, and a hot campaign stage 606. In the cold campaign stage 602, an AT model and/or an AE model (e.g., two-tower ML model 402) may generate cold data 626 such as a seed audience of users 108. In the warm campaign stage 604, the AT model and/or an AE model may generate warm data 628 such as an intermediate audience of users 108 derived from the seed audience of users 108 and activity data 130 of users 108. In the hot campaign stage 606, the AT model and/or an AE model may generate hot data 630 derived from one or more intermediate audiences of users 108 and more activity data 130 of users 108. In one embodiment, for example, the hot data 630 may comprise a user audience 312 comprising a PA segment 636 of users 108 for the content delivery campaign 308.

The campaign stages may be associated with various states of data representing various phases of an AE task when selecting users 108 suitable for a user audience 312 of users 108 of connection network platform 112 for the content delivery campaign 308. A state machine 624 defines the various states of data, such as a cold state 702 (State_Cold) comprising cold data 626, a warm state 704 (State_Warm) comprising warm data 628, and a hot state 706 (State-Hot) comprising hot data 630.

When a user 302 creates a content delivery campaign 308 at a create campaign 708 event using a set of campaign attributes 310, the state machine 624 begins in a cold state 702. In the cold state 702, an AT model and/or AE model generates a seed audience of users 108 for the cold state 702. For example, an AT model initially creates or identifies the seed audience. The AT model may be implemented as an EBR model, a generative AI model, or a BG model. The content delivery system 300 delivers advertisements 314 to an exact match of the users 108 in the seed audience (e.g., cold data 626).

When warm data 628 is ready, the state machine 624 moves to a warm state 704. In the warm state 704, an intermediate audience of users 108 is ready (e.g., warm data 628) for delivery of advertisements 314. The content delivery system 300 enters a warm state after an interval of time (e.g., 2 to 3 days) after cold start, and it keeps refreshing on a periodic basis (e.g., every 6 hours). The content delivery system 300 delivers advertisement 314 to mix of warm data 628 and cold data 626 based on a percentage (e.g., 5%).

When hot data 630 is ready, the state machine 624 moves to a hot state 706. In the hot state, a PA segment 636 of users 108 is ready (e.g., hot data 630) for delivery of advertisements 314. The content delivery system 300 enters a hot state 706 after an interval of time (e.g., 2 to 4 days) after warm data 628 is ready, and it keeps refreshing on a periodic basis (e.g., every 1-2 days).

At some point in time, the user 302 may decide to change one or more campaign attributes 310 of an active content delivery campaign 308. Depending on a given state of the state machine 624 when this occurs, the state machine 624 may revert to a previous state. For example, when the state machine 624 is in a warm state 704 and it detects a change in campaign attributes 310, the state machine 624 reverts to a cold state 702. When the state machine 624 is in a hot state 706 and it detects a change in campaign attributes 310, the state machine 624 reverts to either a warm state 704 or a cold state 702. In some embodiments, these changes in states in response to changes in campaign attributes 310 are controlled by a number of different factors, such as a type of notification system (e.g., flags), consistency issues between campaign versions, campaign stage, campaign attributes 310, book-to-serve latency, data flow synchronization, service level agreements (SLAs), conflicting writing rules, database load, data ingestion pipelines, and other factors.

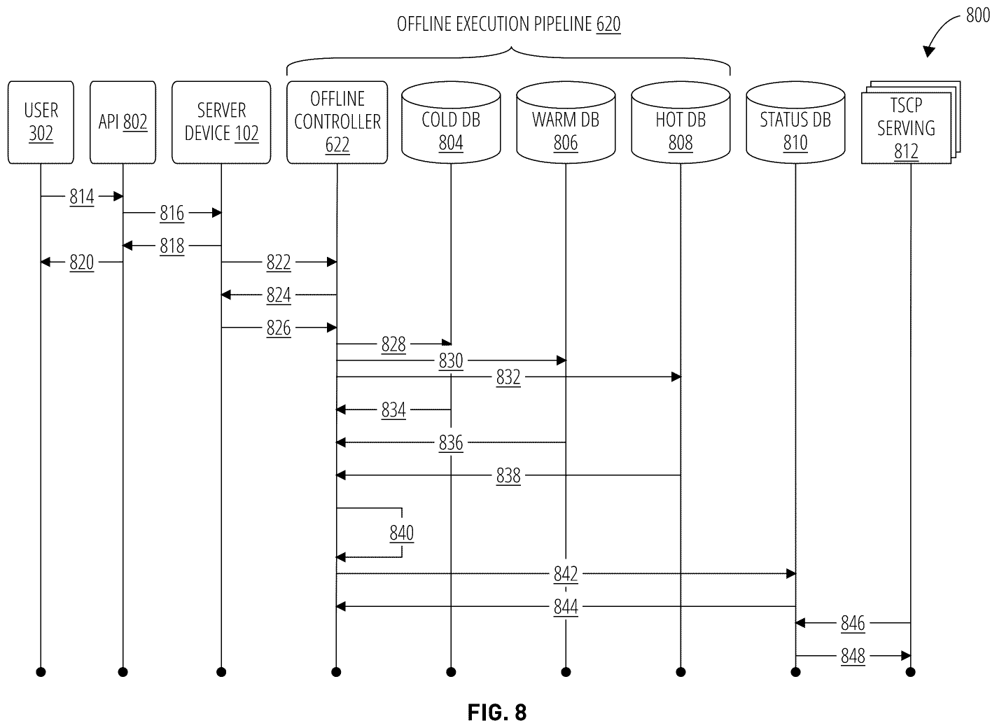

FIG. 8 illustrates a data flow diagram 800. The data flow diagram 800 illustrates an example of a flow of messages and/or information for the logic diagram 600 and state machine 624 of the content delivery system 300.

As depicted in FIG. 8, the data flow diagram 800 comprises a series of messages and/or information flowing between various entities of the content delivery system 300. A user 302 (e.g., an advertiser) defines a set of campaign attributes 310 for a content delivery campaign 308. At some point during the active content delivery campaign 308, the user 302 sends a message 814 to change a campaign attribute of the campaign attributes 310 via an API 802. For example, the message 814 may indicate a change in targeting for the content delivery campaign 308, such as a different geographic area. The API 802 sends a message 816 to the server device 102 of the content delivery system 300. For example, the server device 102 may be executing Kafka server software. The message 816 may comprise a campaign change message. The server device 102 sends a message 818 to the user 302 via the API 802 acknowledging the campaign change. The server device 102 sends a message 822 to the offline controller 622 of the offline execution pipeline 620.

The offline controller 622 operates as a stage controller to control AE operations for various campaign stages of the content delivery campaign 308. The offline controller 622 sends a message 824 to the server device 102 to pull user events collected by the server device 102, such as activity data 130 for users 108. The server device 102 sends a message 826 to the offline controller 622 with the requested user events. The offline controller 622 then sends a message 828, a message 830, and a message 832 to a cold db 804, warm db 806, and hot db 808, respectively, to fetch cold data 626, warm data 628, and hot data 630, respectively. The cold db 804, warm db 806, and hot db 808 send the cold data 626 with cold candidate user identifiers 614, the warm data 628 with warm candidate user identifiers 614, and hot data 630 with hot candidate user identifiers 614, respectively.

The offline controller 622 receives the cold data 626, warm data 628, and hot data 630 generated during various campaign stages from their respective databases, and it initiates custom merge logic to perform a merge operation 840 to merge the cold data 626, warm data 628, and hot data 630. Once the data is merged, the offline controller 622 sends a message 842 to a status db 810, such as data store 126. The message 842 may comprise a notification 634 with a campaign ID 422, a campaign version, a campaign state value 638 for a campaign stage. For example, the notification 634 may have a write command with a data schema such as write <campaignId, <campaign Version, campaign flags>>. The status db 810 stores the notification 634 in a data structure, such as one or more tables to store the data for each campaign stage, in a <key, value> pair, where the key comprises the campaignId and the value comprises <campaign version, campaign flags>. The status db 810 notifies the online controller 610 of the notification 634, and it then sends a message 844 acknowledging receipt of the message 842 with the notification 634.

Once the online controller 610 retrieves the notification 634, the online controller 610 may instantiate one or more serving threads of the content delivery system 300 to send a message 846 to pull data for the various campaign stages from the status db 810. An example of a serving thread is a targeted sponsored content platform (TSCP) serving thread (e.g., TSCP serving 812) designed to help businesses and recruiters run targeted campaigns for talent acquisition and employer branding. Each of the TSCP serving 812 threads delivers or “serves” one or more active content delivery campaigns 308, using parallel processing techniques, to server talent-related campaigns to the intended user audience 312 of users 108 of the connection network platform 112. This involves various components, including an audience targeting component for identifying and targeting the right professionals based on criteria such as job title, skills, experience, and geographic location. The TSCP serving 812 thread delivers content items 134, such as advertisements 314 for job postings, sponsored content, online courses, recommended connections, events, and so forth. The TSCP serving 812 thread displays the advertisements 314 to the selected audience in as part of a user feed, messages, or other sections of the connection network platform 112. The TSCP serving 812 thread may also continuously refine the campaign based on performance metrics to improve reach, engagement, and conversion rates. The TSCP serving 812 thread may include reporting and analytic components, providing insights into how the campaign is performing, allowing recruiters and marketers to measure effectiveness and make data-driven decisions. The TSCP serving 812 thread enables employers to reach qualified candidates efficiently and effectively, using the extensive professional network and data served by the connection network platform 112.

The status db 810 sends a message 848 with the requested data. The online controller 610 delivers the advertisements 314 to a user audience 312 of user 108, represented by the user identifiers 614, and defined by the cold data 626, the warm data 628, and/or the hot data 630.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

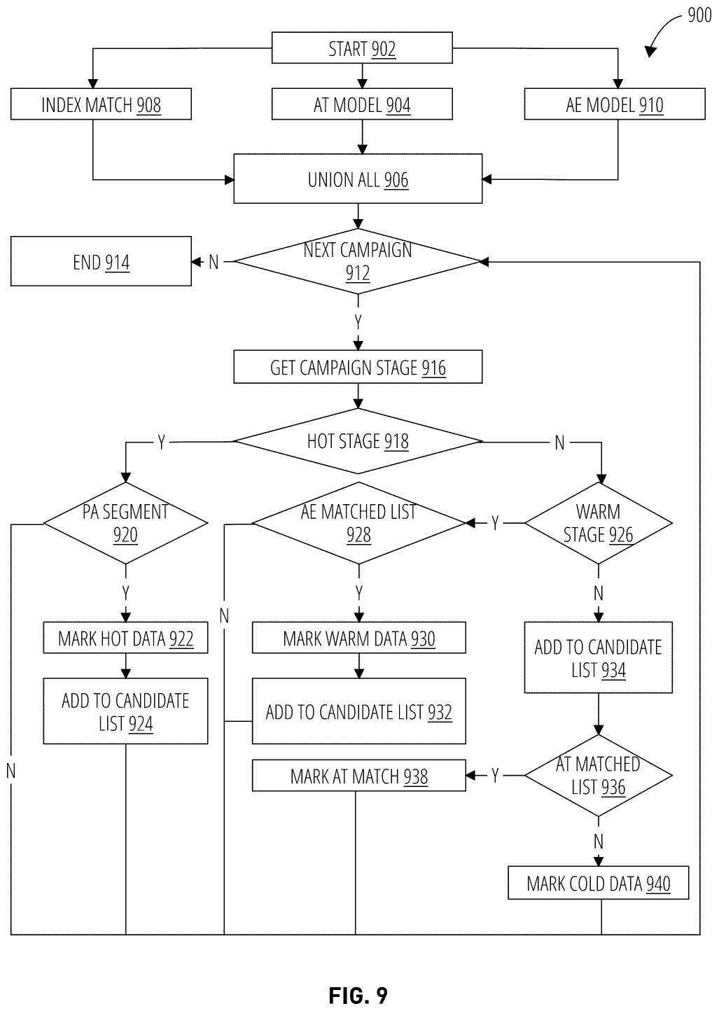

FIG. 9 illustrates a logic flow 900. The logic flow 900 is an example of a logic flow for the custom merge logic and user reset logic suitable to perform merge operations 840 of the data flow diagram 800. In one embodiment, for example, the offline controller 622 of the offline execution pipeline 620 performs the merge operation 840 using the logic flow 900. Embodiments are not limited to this example.

As depicted in FIG. 9, at block 902, the logic flow 900 starts merge operations 840 using the cold data 626, the warm data 628, and the hot data 630 generated by the two-tower ML model 402 implemented at block 904 as AT EBR models and at block 910 as AE EBR models during various campaign stages such as the cold campaign stage 602, the warm campaign stage 604, and the hot campaign stage 606, respectively. At block 906, the offline controller 622 performs a union all operation of the different types of data.

At decision block 912, the offline controller 622 decides whether to process a next content delivery campaign 308. If there are no active content delivery campaign 308 ready to merge data, the logic flow 900 ends at block 914. If there is an active content delivery campaign 308 ready to merge data, at block 916, the offline controller 622 executes a getCampaignStage(campaignId, campaign.version) procedure to retrieve a campaign stage with data ready for merging, as defined by the notification 634 stored in the status db 810. At decision block 918, the offline controller 622 decides whether the campaign stage is a hot campaign stage 606.

If the offline controller 622 determines a hot campaign stage 606 at decision block 918, control passes to decision block 920 to process hot data 630. At decision block 920, the offline controller 622 determines whether hot data 630 from the hot campaign stage 606 has a PA segment 636 for the user audience 312. If the offline controller 622 determines that the hot campaign stage 606 does not have a PA segment 636 at decision block 920, control is transferred back to decision block 912 to process a next content delivery campaign 308. However, if the offline controller 622 determines that the hot campaign stage 606 does have a PA segment 636 at decision block 920, the offline controller 622 executes a markTscpHit(Hot) procedure at block 922. At block 924, the offline controller 622 executes an add2Candidate List (campaign) procedure to add user identifiers 614 for users 108 to a list of user identifiers 614 for the user audience 312, and it passes control back to decision block 912 to process a next campaign.

If the offline controller 622 does not determine a hot campaign stage 606 at decision block 918, control passes to decision block 926 to process warm data 628. At decision block 926, the offline controller 622 determines whether warm data 628 from a warm campaign stage 604 is ready for merging. If not, the offline controller 622 executes an add2CandidateList(campaign) procedure to process cold data 626, and it passes control to decision block 936. At decision block 936, the offline controller 622 determines whether the ready campaign data is in the AT EBR matched list. If not, the offline controller 622 executes a markTscpHit(Cold) procedure, and it returns control to the decision block 912 to process the next campaign. If so, the offline controller 622 executes a markTscpHit(AT_Match) procedure, and it returns control to the decision block 912 to process the next campaign.

If the offline controller 622 does determine a hot campaign stage 606 at decision block 918, control passes to decision block 926 to process warm data 628. At decision block 926, the offline controller 622 determines whether warm data 628 from a warm campaign stage 604 is ready for merging. If so, the offline controller 622 passes control to decision block 928 to determine whether the ready campaign data is in the AE EBR matched list. If not, the offline controller 622 passes control to decision block 912 to process the next campaign. If so, the offline controller 622 executes a markTscpHit(Warm) procedure at block 930. The offline controller 622 then executes an add2 CandidateList (campaign) procedure to process the warm data 628. The offline controller 622 then passes control to the decision block 912 to process the next campaign.

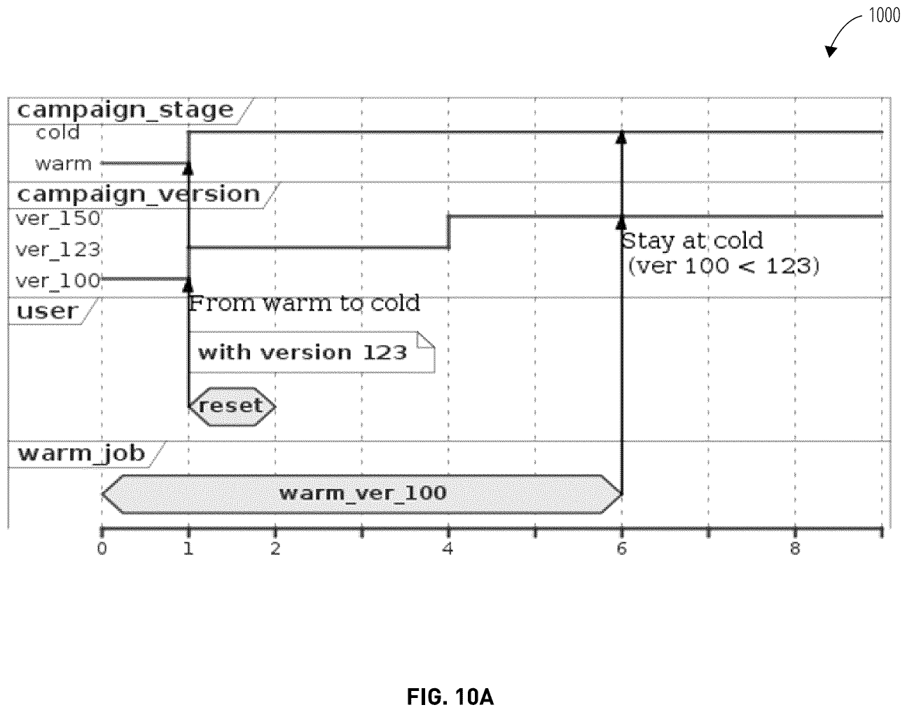

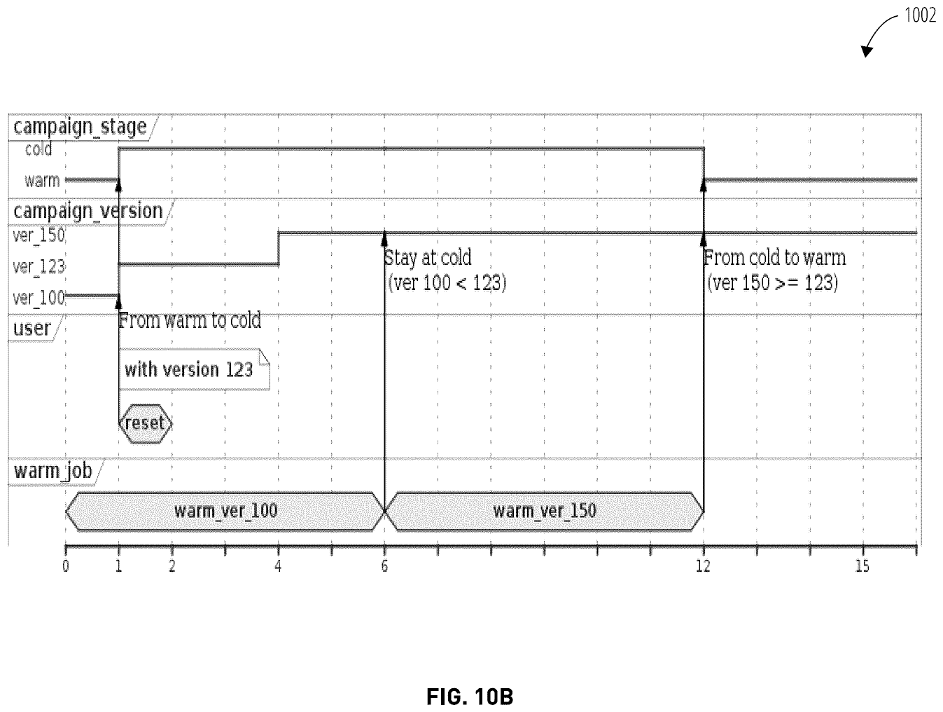

FIG. 10A illustrates a timing diagram 1000. The timing diagram 1000 is an example of operations performed by the logic flow 900 to perform merge operations 840 of the data flow diagram 800. Embodiments are not limited to this example.

As previously described, an ML model 230 such as two-tower ML model 402 may perform AT and AE tasks using various campaign attributes 310 associated with a content delivery campaign 308, such as a campaign start date, campaign stop date, number of advertisements, target demographics, types of products and/or services, geo-locations, languages, and a host of other attributes associated with a given campaign. When an advertiser changes any of the campaign attributes 310 after a campaign has started, however, the ML model 230 must reinitialize the entire AT and AE process to use the new set of campaign attributes 310. This reset may cause a delay of hours or days as the content delivery system 300 attempts to find a new PA segment 636 relevant to the new campaign attributes 310. The content delivery system 300 described herein uses custom reset logic to reuse previous output from the AT and/or AE models to jumpstart the AT and/or AE tasks with the new campaign attributes 310.

In addition to the offline controller 622 implementing custom merge logic executing logic flow 900 to merge data from the different campaign stages, the logic flow 900 also includes custom reset logic to solve any merging conflicts in response to a “user reset” signal generated when the user 302 changes one or more campaign attributes 310 for an active content delivery campaign 308. This is accomplished, in part, by implementation of different campaign versions for a given content delivery campaign 308, such as through the data structure <campaignId, <campaign Version, campaign flags>> stored in the status db 810. In one embodiment, for example, the offline controller 622 may use the campaignVersion value (e.g., an information element such as campaign.version) for a campaignID to control reset of campaign stages using a set of merging rules. An example of a merging rule is “for a user reset (API) event, higher or equal campaign.version actions can overwrite lower campaign.version actions.” Examples of equal version cases include a job failure retry, a job replay, a hot job with a stale warm job, and so forth. Other example of merging rules include “for a user reset (API) cold event, overwrite pipeline stage warm/hot from warm/hot to cold”, “for a user reset (API) cold event, overwrite previous user stage (cold) and stay with cold”, “for a user reset (API) warm/hot event, overwrite user stage (cold) from cold to warm/hot. Embodiments are not limited to these examples of merging rules, and other merging rules may be defined for a given implementation.

As depicted in FIG. 10A, the timing diagram 1000 provides an example case where a user reset signal overwrites a pipeline stage. As depicted in timing diagram 1000, at time 1:00, a campaign stage is a warm campaign stage 604, and a campaign.version is set to a value of 100. At time 1:00, a user 302 resets the campaign, with a campaign.version 123. Since campaign.version 123≥campaign.version 100, the offline controller 622 resets the campaign stage to cold campaign stage 602. At time 6:00, the warm campaign stage 604 generates new data based on campaign data from time 0:00 (campaign.version 100), and the offline controller 622 sets a campaign stage to remain with the cold campaign stage 602 (e.g., campaign.version 100<campaign.version 123). When a campaign stage is a cold campaign stage 602, a user reset action needs to overwrite the stage (warm to cold) as campaign.version 123≥campaign.version 100. However, a warm campaign stage 604 should not overwrite the campaign stage (cold to warm) as campaign.version 100<campaign.version 123.

FIG. 10B illustrates a timing diagram 1002. The timing diagram 1000 is an example of operations performed by the logic flow 900 to perform merge operations 840 of the data flow diagram 800. Embodiments are not limited to this example.

As depicted in FIG. 10B, the timing diagram 1002 provides an example case where a pipeline stage overwrites a user reset signal for a given campaign stage. As depicted in timing diagram 1002, at time 0:00, a campaign stage is a warm campaign stage 604, and a campaign.version is set to a value of 100. At time 1:00, a user 302 resets the campaign, with a campaign.version 123. Since campaign.version 123≥campaign.version 100, the offline controller 622 resets the campaign stage from the warm campaign stage 604 to a cold campaign stage 602. At time 6:00, when the warm job is finished, since it used campaign.version 100 which is less than campaign.version 123, the offline controller 622 stays in the cold campaign stage 602. At time 12:00, the warm pipeline generates new data based on campaign data from time 6:00 (campaign.version 150), and the offline controller 622 sets a campaign stage from the cold campaign stage 602 to the warm campaign stage 604 since campaign.version 150 is ≥campaign.version 100.

The custom reset logic of the logic flow 900 has technical benefits relative to conventional systems. For example, the custom reset logic provides flexibility to control/define campaign flags in one place, provides clear campaign stage information (e.g., a single flag) for the online service, and it works for hot campaign stage 606 to warm campaign stage 604 cases as well. However, this comes at a potential cost of longer book-to-serve latency times, additional efforts for user reset (API) and offline data flow synchronization using a custom campaign.version value, potential consistency issues between campaign stage and campaign objectives, and a potential for the status db 810 to go down which would slow down merging operations.

FIG. 11 illustrates an apparatus 1100. The apparatus 1100 depicts a training device 1102 suitable for training an ML model 1120 for the connection network system 100. Specifically, the training device 1102 trains the ML model 1120 to perform inferencing operations in support of the content delivery application 120, ranking model 122, or recommendation model 124.

As depicted in FIG. 11, the training device 1102 includes a processing circuitry 1104 and a memory unit 1106. The memory unit 1106 may store a set of ML components 1108 to support various AI/ML techniques. The ML components 1108 comprise a data collector 1110, a model trainer 1112, a model evaluator 1114 and a model inferencer 1116.

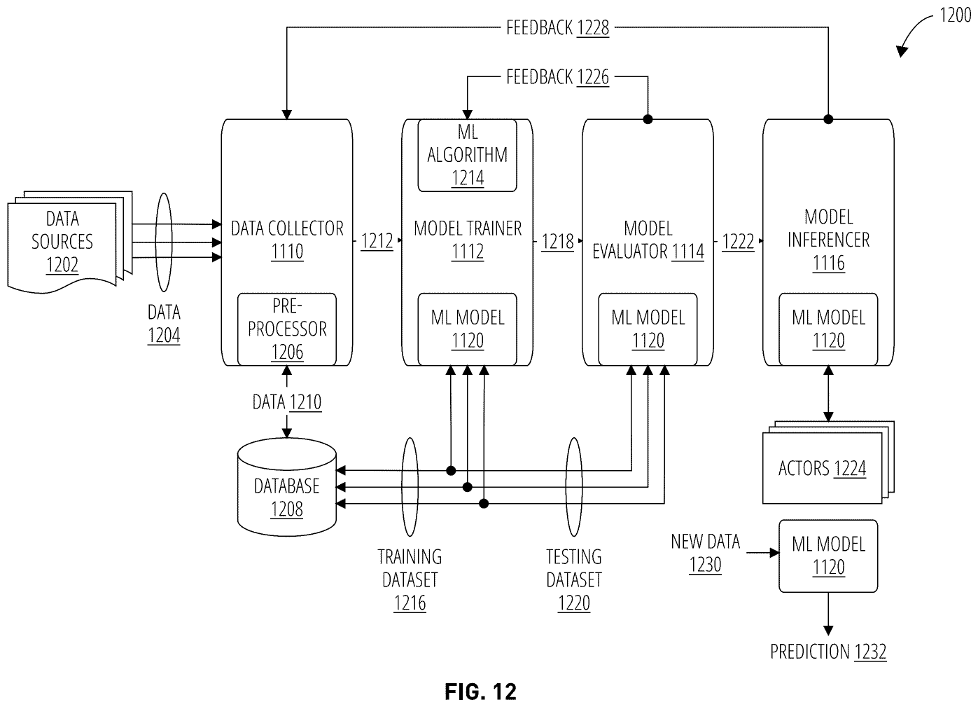

In general, the data collector 1110 collects data 1118 from one or more data sources to use as training data for an ML model 1120. The data collector 1110 collects different types of data 1118, such as text information, audio information, image information, video information, graphic information, and so forth. The model trainer 1112 receives as input the collected data and uses a portion of the collected data as test data for an AI/ML algorithm to train the ML model 1120. The model evaluator 1114 evaluates and improves the trained ML model 1120 using a portion of the collected data as test data to test the ML model 1120. The model evaluator 1114 also uses feedback information from the deployed ML model 1120. The model inferencer 1116 implements the trained ML model 1120 to receive as input new unseen data, generate one or more inferences on the new data, and output a result such as an alert, a recommendation or other post-solution activity. An exemplary AI/ML architecture for the ML components 1108 is described in more detail with reference to FIG. 12.

FIG. 12 illustrates a logic diagram 1200 suitable for use by the training device 1102 to generate the ML model 1120 for deployment by an inferencing device of the connection network platform 112. The logic diagram 1200 is an example of a system suitable for implementing various AI techniques and/or ML techniques to perform various training tasks on behalf of the various devices of the connection network system 100.

In one embodiment, the training device 1102 trains an ML model 1120. In the context of machine learning, “training” refers to the process of teaching a model to recognize patterns and make predictions based on data. This involves initializing the model with initial parameters, which are often set randomly. The model is then provided with a dataset that includes input features and the corresponding correct outputs, often referred to as labels or targets. As the model processes this data, it generates predictions based on its current parameters. The difference between these predictions and the actual target values is measured using a loss function, which quantifies the model's accuracy. The goal is to minimize this loss. To achieve this, the model's parameters are adjusted using optimization techniques such as gradient descent. By continuously refining these parameters, the model gradually improves its predictions. This cycle of making predictions, calculating the loss, and updating parameters is repeated many times, allowing the model to learn and improve over time. The ultimate aim of training is to produce a model that performs well not just on the training data but also on new, unseen data. This ensures the model's ability to generalize, making it effective in real-world applications.

In various embodiments, the training device 1102 may pretrain an ML model 1120 before training the ML model 1120 or trains a pretrained ML model 1120. In the context of machine learning, “pretraining” refers to the initial phase of training a model on a large, general dataset before fine-tuning it on a more specific task or dataset. This approach is particularly common in deep learning, especially with models like neural networks that can benefit from learning basic patterns and representations from broad data before being specialized for a particular application. During pretraining, the model is exposed to a diverse set of data, allowing it to learn fundamental features or representations that are useful across various tasks. For example, in natural language processing, a model might be pretrained on a large corpus of text to understand language structure and grammar. Once the model has acquired this general knowledge, it can be fine-tuned on a smaller, task-specific dataset, such as sentiment analysis or translation. Pretraining is beneficial because it allows the model to start with a good foundation of knowledge, which can lead to better performance and faster convergence during the fine-tuning phase. It also helps when there is limited labeled data for the specific task, as the pretrained model already has a strong understanding from the broader data.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the logic diagram 1200 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 1120, evaluate performance of the trained ML model 1120, and deploy the tested ML model 1120 as the trained ML model 1120 in a production environment, and continuously monitor and maintain it.

The ML model 1120 is a mathematical construct used to predict outcomes based on a set of input data. The ML model 1120 is trained using large volumes of training dataset 1216, and it can recognize patterns and trends in the training dataset 1216 to make accurate predictions. The ML model 1120 is derived from an ML algorithm 1214. A data set is fed into the ML algorithm 1214 which trains an ML model 1120 to “learn” a function that produces mappings between a set of inputs and a set of outputs with a reasonably high accuracy. Given a sufficiently large enough set of inputs and outputs, the ML algorithm 1214 finds the function for a given task. This function may even be able to produce the correct output for input that it has not seen during training. A data scientist prepares the mappings, selects and tunes the ML algorithm 1214, and evaluates the resulting model performance. Once the ML model 1120 is sufficiently accurate on test data, it can be deployed for production use.

The ML algorithm 1214 is generally a computational procedure used to identify patterns within data and make inferences or predictions without being explicitly programmed for every scenario. The ML algorithm 1214 can process input data, learn from it by adjusting internal parameters, and then apply the learned information to new, unseen data. The ML algorithm 1214 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1214 of the logic diagram 1200 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 12, the logic diagram 1200 includes a set of data sources 1202 to source data 1204 for the training device 1102. Data sources 1202 may comprise any device capable generating, processing, storing or managing data 1204 suitable for a ML system. Examples of data sources 1202 include without limitation databases, web scraping, sensors and Internet of Things (IoT) devices, image and video cameras, audio devices, text generators, publicly available databases, private databases, and many other data sources 1202. The data sources 1202 may be remote from the training device 1102 and accessed via a network, local to the training device 1102 and accessed via a network interface, or may be a combination of local and remote data sources 1202.

The data sources 1202 source difference types of data 1204. By way of example and not limitation, the data 1204 includes structured data from relational databases, such as customer profiles, transaction histories, or product inventories. The data 1204 includes unstructured data from websites such as customer reviews, news articles, social media posts, or product specifications. The data 1204 includes data from temperature sensors, motion detectors, and smart home appliances. The data 1204 includes image data from medical images, security footage, or satellite images. The data 1204 includes audio data from speech recognition, music recognition, or call centers. The data 1204 includes text data from emails, chat logs, customer feedback, news articles or social media posts. The data 1204 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1204 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1202 are communicatively coupled to a data collector 1110. The data collector 1110 gathers relevant data 1204 from the data sources 1202. Once collected, the data collector 1110 may use a pre-processor 1206 to make the data 1204 suitable for analysis. This involves data cleaning, transformation, and feature engineering. Data preprocessing is a critical step in ML as it directly impacts the accuracy and effectiveness of the ML model 1120. The pre-processor 1206 receives the data 1204 as input, processes the data 1204, and outputs pre-processed data 1210 for storage in a database 1208. Examples for the database 1208 includes a hard drive, solid state storage, and/or random access memory (RAM).

The data collector 1110 is communicatively coupled to a model trainer 1112. The model trainer 1112 performs AI/ML model training, validation, and testing which may generate model performance metrics as part of the model testing procedure. The model trainer 1112 receives the pre-processed data 1210 as input 1212 or via the database 1208. The model trainer 1112 implements a suitable ML algorithm 1214 to train an ML model 230 on a set of training dataset 1216 from the pre-processed data 1210. The training process involves feeding the pre-processed data 1210 into the ML algorithm 1214 to produce or optimize an ML model 1120. The training process adjusts its parameters until it achieves an initial level of satisfactory performance.

The model trainer 1112 is communicatively coupled to a model evaluator 1114. After an ML model 1120 is trained, the ML model 1120 needs to be evaluated to assess its performance. This is done using various metrics such as accuracy, precision, recall, and F1 score. The model trainer 1112 outputs the ML model 1120, which is received as input 1212 or from the database 1208. The model evaluator 1114 receives the ML model 230 as input 1218, and it initiates an evaluation process to measure performance of the ML model 1120. The evaluation process includes providing feedback 1226 to the model trainer 1112. The model trainer 1112 re-trains the ML model 1120 to improve performance in an iterative manner.

The model evaluator 1114 is communicatively coupled to a model inferencer 1116. The model inferencer 1116 provides AI/ML model inference output (e.g., inferences, predictions or decisions). Once the ML model 1120 is trained and evaluated, it is deployed in a production environment where it is used to make predictions on new data. The model inferencer 1116 receives the evaluated ML model 1120 as input 1222. The model inferencer 1116 uses the evaluated ML model 1120 to produce insights or predictions on real data, which is deployed as a final production ML model 1120. The inference output of the ML model 1120 is use case specific. The model inferencer 1116 also performs model monitoring and maintenance, which involves continuously monitoring performance of the ML model 1120 in the production environment and making any necessary updates or modifications to maintain its accuracy and effectiveness. The model inferencer 1116 provides feedback 1226 to the data collector 1110 to train or re-train the ML model 1120. The feedback 1226 includes model performance feedback information, which is used for monitoring and improving performance of the ML model 1120.

Some or all of the model inferencer 1116 is implemented by various actors 1224 in the logic diagram 1200, including the ML model 1120 of the connection network platform 112, for example. The actors 1224 use the deployed ML model 1120 on new data to make inferences or predictions for a given task, and output a prediction 1232. The actors 1224 implement the model inferencer 1116 locally, or remotely receives outputs from the model inferencer 1116 in a distributed computing manner. The actors 1224 trigger actions directed to other entities or to itself. The actors 1224 provide feedback 1228 to the data collector 1110 via the model inferencer 1116. The feedback 1228 comprise data needed to derive training data, inference data or to monitor the performance of the ML model 1120 and its impact to the network through updating of key performance indicators (KPIs) and performance counters.

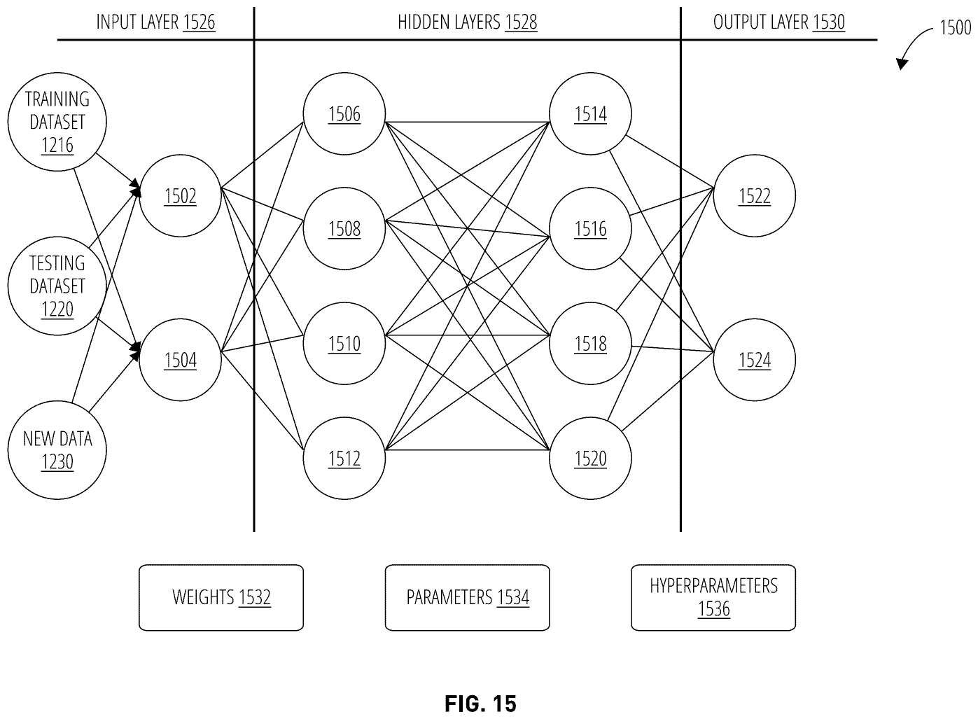

As previously described with reference to FIGS. 1, 2, the connection network system 100 and/or the apparatus 1100 may implement some or all of the logic diagram 1200 to support various use cases and solutions for various AI/ML tasks. In various embodiments, the training device 1102 of the apparatus 1100 uses the logic diagram 1200 to generate and train the ML model 230 for use by the connection network platform 112 for the client application 110. In one embodiment, for example, the training device 1102 may train the ML model 1120 as a neural network, as described in more detail with reference to FIG. 15. Other use cases and solutions for AI/ML are possible as well, and embodiments are not limited in this context.

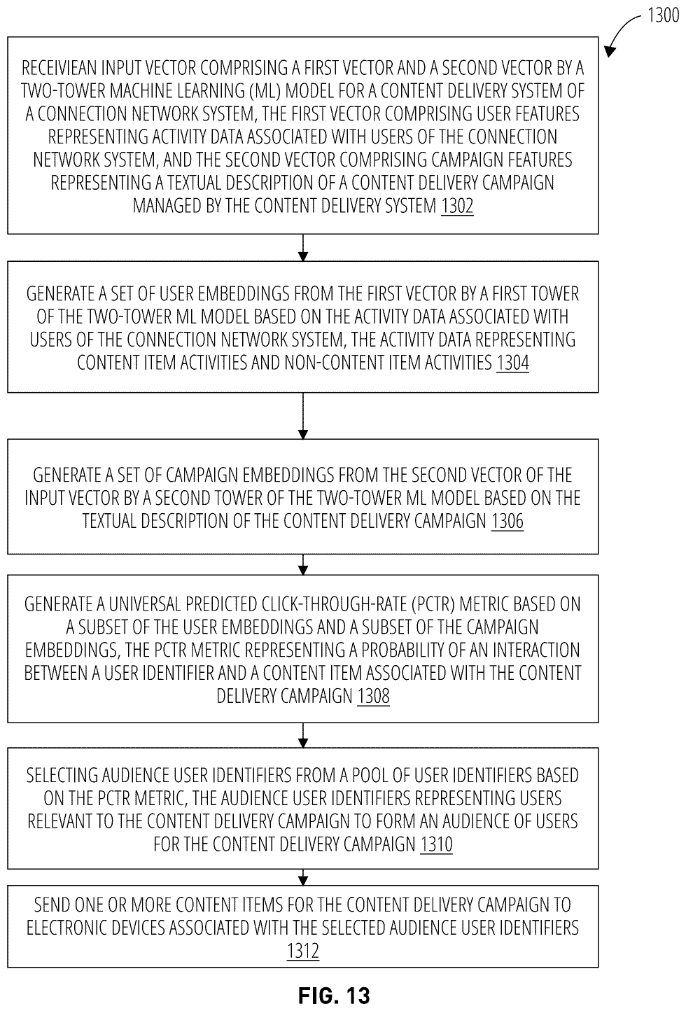

FIG. 13 illustrates an embodiment of a logic flow 1300. The logic flow 1300 may be representative of some or all of the operations executed by one or more embodiments described herein. For example, the logic flow 1300 may include some or all of the operations performed by devices or entities within the connection network platform 112 of the connection network system 100, such as the server device 102 and/or the client device 104. More particularly, the logic flow 1300 illustrates an example where the server device 102 performs a set of training and/or inferencing operations of a ML model such as an ML model 230 to support one or more network services 146 provided by the connection network platform 112 of the connection network system 100. For example, the logic flow 1300 may be performed by the server device 102 and/or the client device 104 using a content delivery system 300, ML architecture 400, transformer model 500, logic diagram 600, data flow diagram 800, logic flow 900, timing diagram 1000, timing diagram 1002, apparatus 1100, and/or logic diagram 1200.

As depicted in logic flow 1300, at block 1302 the logic flow 1300 includes receiving an input vector comprising a first vector and a second vector by a two-tower machine learning (ML) model for a content delivery system of a connection network system, the first vector comprising user features representing activity data associated with users of the connection network system, and the second vector comprising campaign features representing a textual description of a content delivery campaign managed by the content delivery system. At block 1304, the logic flow 1300 includes generating a set of user embeddings from the first vector by a first tower of the two-tower ML model based on the activity data associated with users of the connection network system, the activity data representing content item activities and non-content item activities. At block 1306, the logic flow 1300 includes generating a set of campaign embeddings from the second vector of the input vector by a second tower of the two-tower ML model based on the textual description of the content delivery campaign. At block 1308, the logic flow 1300 includes generating a universal predicted click-through-rate (pCTR) metric based on a subset of the user embeddings and a subset of the campaign embeddings, the pCTR metric representing a probability of an interaction between a user identifier and a content item associated with the content delivery campaign. At block 1310, the logic flow 1300 includes selecting audience user identifiers from a pool of user identifiers based on the pCTR metric, the audience user identifiers representing users relevant to the content delivery campaign to form an audience of users for the content delivery campaign. At block 1312, the logic flow 1300 includes sending one or more content items for the content delivery campaign to electronic devices associated with the selected audience user identifiers.

By way of example, the two-tower ML model 402 receives an input vector 408 comprising a first vector 410 and a second vector 412 for a content delivery system 300 of a connection network system 100. The first vector 410 comprises user features representing user data 128 and activity data 130 associated with users 108 of the connection network system 100. The second vector 412 comprises campaign features representing, among other features, textual features 424 such as a textual description of a content delivery campaign managed by the content delivery system 300. The two-tower ML model 402 generates a set of one or more user embeddings 440 from the first vector 410 by a first tower 404 of the two-tower ML model 402 based on the user data 128 and activity data 130 associated with users 108 of the connection network system 100. The activity data 130 comprises content item activity data 430 representing content item activities and non-content item activity data 432 representing non-content item activities. The two-tower ML model 402 generates a set of one or more campaign embeddings 448 from the second vector 412 of the input vector 408 by a second tower 406 of the two-tower ML model 402 based on the textual description of the content delivery campaign 308. The two-tower ML model 402 generates a universal pCTR metric 452 based on a subset of the user embeddings 440 and a subset of the campaign embeddings 448. The universal pCTR metric 452 represents a probability of an interaction between a user identifier 614 and a content item such as advertisement 314 associated with the content delivery campaign 308. The content delivery system 300 uses logic to select audience user identifiers 614 from a pool of user identifiers 614 based on the universal pCTR metric 452. The audience user identifiers 614 represent users 108 relevant to the content delivery campaign 308 to form user audience 312 for the content delivery campaign 308. The logic sends one or more content items 134, such as advertisements 314, for the content delivery campaign 308 to electronic devices associated with the selected audience user identifiers, such as client devices 104 for the users 108 comprising part of the user audience 312.

In one embodiment, for example, the content item activities comprise interactions between a user identifier 614 and a content item, such as an advertisement 314, from the content delivery campaign 308. The non-content item activities comprise interactions between a user identifier 614 and a product or service of the connection network system 100.

In one embodiment, for example, the two-tower ML model 402 receives the textual description from a generative artificial intelligence (AI) model, such as GAI 454. The two-tower ML model 402 extracts textual features 424 for the second vector 412 from the creative content within the textual description.

In one embodiment, for example, a matching layer 450 of the two-tower ML model 402 matches one or more user embeddings 440 with one or more campaign embeddings 448 using a similarity measure (e.g., cosine similarity) to form a set of matched embeddings. The matching layer 450 generates the universal pCTR metric 452 based on the matched embeddings.

In one embodiment, for example, a training device 1102 may generate a training dataset 1216 comprising one or more training datapoints, wherein a training datapoint represents a click action on a landing web page of the connection network system 100. The training device 1102 trains the two-tower ML model 402 using the training dataset 1216.

In one embodiment, for example, the two-tower ML model 402 receives a concatenated vector by the first tower 404 of the two-tower ML model 402, extracts behavioral pattern features from the content item activity data 430 and the non-content item activity data 432 of a shared embedding layer 426 using a behavioral pattern behavioral extraction layer 434 of the first tower 404, encodes a set of user features based on the behavioral pattern features using a user feature interaction layer 436 of the first tower 404, generates a user embedding 440 for the set of user embeddings 440 based on the user features using a fully connected layer 438 of the first tower 404, the fully connected layer 438 comprising neurons using an hyperbolic tangent (tanh) as an activation function.

In one embodiment, for example, the two-tower ML model 402 receives a concatenated vector by the second tower 406 of the two-tower ML model 402, encodes a set of campaign features based on the textual descriptions of the content delivery campaign 308 from the GAI 454 using a campaign feature interaction layer 444 of the second tower 406, generates a campaign embedding 448 for the set of campaign embeddings 448 based on the campaign features using a fully connected layer 446 of the second tower 406, the fully connected layer 446 comprising neurons using an hyperbolic tangent (tanh) as an activation function.

In one embodiment, for example, a first version of the two-tower ML model 402 operates in an offline execution pipeline 620 and a second version of the two-tower ML model 402 operates in an online execution pipeline 608 of the content delivery system 300 of the connection network system 100. The online execution pipeline 608 includes an online controller 610 that serves advertisement 314 to users of the user audience 312. The offline execution pipeline 620 includes an offline controller 622 (e.g., a stage controller) that generates candidate user identifiers 614 in various campaign stages using an AT EBR model and/or an AE EBR model. The campaign stages may include a cold campaign stage 602, a warm campaign stage 604, and a hot campaign stage 606.

When cold data 626, warm data 628, and/or hot data 630 is ready, the offline controller 622 sends a notification 634 to a status db 810. The online controller 610 selects the user identifiers 614 from the pool of user identifiers 614 based on the universal pCTR metric 452 in multiple campaign stages of the content delivery campaign, the multiple campaign stages comprising a cold campaign stage 602, a warm campaign stage 604, and a hot campaign stage 606.

In one embodiment, for example, the offline controller 622 selects a first set of candidate user identifiers 614 from the pool of user identifiers 614 based on the universal pCTR metric 452 in a cold campaign stage (e.g., cold data 626) of the content delivery campaign 308. The offline controller 622 selects a second set of candidate user identifiers 614 from the pool of user identifiers 614 based on the universal pCTR metric 452 in a warm campaign stage 604 of the content delivery campaign 308. The offline controller 622 selects a third set of candidate user identifiers 614 from the pool of user identifiers 614 based on the universal pCTR metric 452 in a hot campaign stage 606 of the content delivery campaign 308. The offline controller 622 generates a notification 634 that includes a campaign state value 638 representing a ready state for cold data 626 of the cold campaign stage 602, warm data 628 of the warm campaign stage 604, or hot data 630 of the hot campaign stage 606 when the cold campaign stage 602, the warm campaign stage 604, or the hot campaign stage 606 is complete and ready for merger operations to form the user audience 312. The online controller 610 then servers content items 134, such as advertisements 314, to the users 108 of the user audience 312 of the connection network platform 112 based on the user identifiers 614 for the users 108.

In one embodiment, for example, the offline controller 622 detects a user reset event of a campaign attribute of the content delivery campaign 308. The offline controller 622 retrieves a set of user events associated with the content delivery campaign 308, retrieves a first set of candidate user identifiers 614, a second set of candidate user identifiers 614, and a third set of candidate user identifiers 614 for a cold campaign stage 602, a warm campaign stage 604, and a hot campaign stage 606, respectively. The offline controller 622 performs merge operations 840 to merge the first set of candidate user identifiers 614, the second set of candidate user identifiers 614, and the third set of candidate user identifiers 614 based on a set of merge rules executed by merge logic in an offline execution pipeline 620 of the content delivery system 300. The merge rules guide a reset of a given campaign stage by another campaign stage to optimize reuse of the cold data 626, warm data 628, and/or hot data 630. In one embodiment, the merge rules are based on a campaign version value associated with a version of a content delivery campaign 308 that is in operation when the user reset signal is received by the offline controller 622.

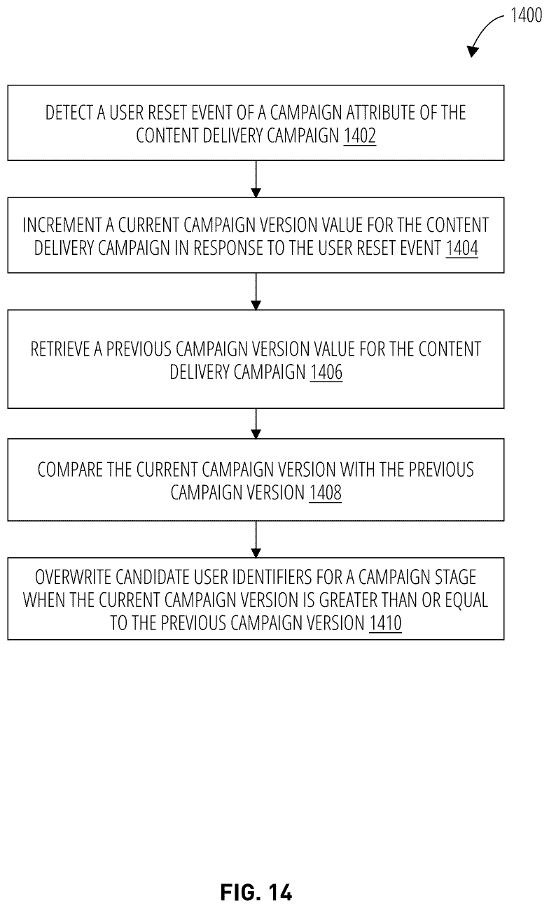

FIG. 14 illustrates an embodiment of a logic flow 1400. The logic flow 1400 may be representative of some or all of the operations executed by one or more embodiments described herein. For example, the logic flow 1400 may include some or all of the operations performed by devices or entities within the connection network platform 112 of the connection network system 100, such as the server device 102 and/or the client device 104. More particularly, the logic flow 1300 illustrates an example where the server device 102 performs a set of inferencing operations of a ML model such as a generative AI model to support one or more network services 146 provided by the connection network platform 112 of the connection network system 100. For example, the logic flow 1400 may be performed by the server device 102 and/or the client device 104 using a content delivery system 300, ML architecture 400, transformer model 500, logic diagram 600, data flow diagram 800, logic flow 900, timing diagram 1000, timing diagram 1002, apparatus 1100, and/or logic diagram 1200.

As depicted in logic flow 1400, at block 1402 the logic flow 1400 includes detecting a user reset event resetting a campaign attribute of an active content delivery campaign. At block 1404, the logic flow 1400 includes incrementing a current campaign version value for the content delivery campaign in response to the user reset event. At block 1406, the logic flow 1400 includes retrieving a previous campaign version value for the content delivery campaign. At block 1408, the logic flow 1400 includes comparing the current campaign version with the previous campaign version. At block 1410, the logic flow 1400 includes overwriting candidate user identifiers for a campaign stage when the current campaign version is greater than or equal to the previous campaign version.

By way of example, the offline controller 622 detects a user reset event via an API 802 resetting one or more campaign attributes 310 of an active content delivery campaign 308. The offline controller 622 increments a current campaign version value (campaign.version) for the content delivery campaign 308 in response to the user reset event. The offline controller 622 retrieves a previous campaign version value for the content delivery campaign 308. The offline controller 622 compares the current campaign version with the previous campaign version, and it overwrites candidate user identifiers 614 for a hot campaign stage 606 in accordance with a set of merge rules. In one embodiment, for example, a merge rule defines an overwrite event when the current campaign version is greater than or equal to the previous campaign version.

FIG. 15 illustrates an embodiment of an artificial neural network 1500. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1500 comprises multiple node layers, containing an input layer 1526, one or more hidden layers 1528, and an output layer 1530. Each layer comprises one or more nodes, such as nodes 1502 to 1524. As depicted in FIG. 15, for example, the input layer 1526 has nodes 1502, 1504. The artificial neural network 1500 has two hidden layers 1528, with a first hidden layer having nodes 1506, 1508, 1510 and 1512, and a second hidden layer having nodes 1514, 1516, 1518 and 1520. The artificial neural network 1500 has an output layer 1530 with nodes 1522, 1524. Each node 1502 to 1524 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1500 relies on training dataset 1216 to learn and improve accuracy over time. However, once the artificial neural network 1500 is fine-tuned for accuracy, and tested on testing dataset 1220, the artificial neural network 1500 is ready to classify and cluster new data 1230 at a high velocity. Tasks in speech recognition or image recognition can take minutes versus hours when compared to the manual identification by human experts.

Each individual node 1502 to 424 is a linear regression model, composed of input data, weights, a bias (or threshold), and an output. The linear regression model may have a formula similar to Equation (10), as follows:

$$\sum wixi + bias = w 1 \times 1 + w 2 \times 2 + w 3 + 3 + bias \\ output = f ( x ) = 1 if \sum w 1 \times 1 + b >= 0 ; 0 if \sum w 1 \times 1 + b < 0 \qquad EQUATION ( 10 )$$

Once an input layer 1526 is determined, a set of weights 1532 are assigned. The weights 1532 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1500 as a feedforward network.

In one embodiment, the artificial neural network 1500 leverages sigmoid neurons, which are distinguished by having values between 0 and 1. Since the artificial neural network 1500 behaves similarly to a decision tree, cascading data from one node to another, having x values between 0 and 1 will reduce the impact of any given change of a single variable on the output of any given node, and subsequently, the output of the artificial neural network 1500.

The artificial neural network 1500 has many practical use cases, like image recognition, speech recognition, text recognition or classification. The artificial neural network 1500 leverages supervised learning, or labeled datasets, to train the algorithm. As the model is trained, its accuracy is measured using a cost (or loss) function. This is also commonly referred to as the mean squared error (MSE). An example of a cost function is shown in Equation (2), as follows:

$$Cost Function = M S E = \frac{1}{2 m} {\sum }_{i = 1}^{m} {( {y}_{i} - {y}_{i} )}^{2} \to MIN \qquad EQUATION ( 11 )$$

Where i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1534 of the model adjust to gradually converge at the minimum.

In one embodiment, the artificial neural network 1500 is feedforward, meaning it flows in one direction only, from input to output. In one embodiment, the artificial neural network 1500 uses backpropagation. Backpropagation is when the artificial neural network 1500 moves in the opposite direction from output to input. Backpropagation allows calculation and attribution of errors associated with each neuron 1502 to 1524, thereby allowing adjustment to fit the parameters 1534 of the ML model 230 appropriately.

The artificial neural network 1500 is implemented as different neural networks depending on a given task. Neural networks are classified into different types, which are used for different purposes. In one embodiment, the artificial neural network 1500 is implemented as a feedforward neural network, or multi-layer perceptrons (MLPs), comprised of an input layer 1526, hidden layers 1528, and an output layer 1530. While these neural networks are also commonly referred to as MLPs, they are actually comprised of sigmoid neurons, not perceptrons, as most real-world problems are nonlinear. Trained data 1204 usually is fed into these models to train them, and they are the foundation for computer vision, natural language processing, and other neural networks. In one embodiment, the artificial neural network 1500 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1500 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1500 is implemented as any type of neural network suitable for a given operational task of system 200, and the MLP, CNN, and RNN are merely a few examples. Embodiments are not limited in this context.

The artificial neural network 1500 includes a set of associated parameters 1534. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1500 is implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 1536. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

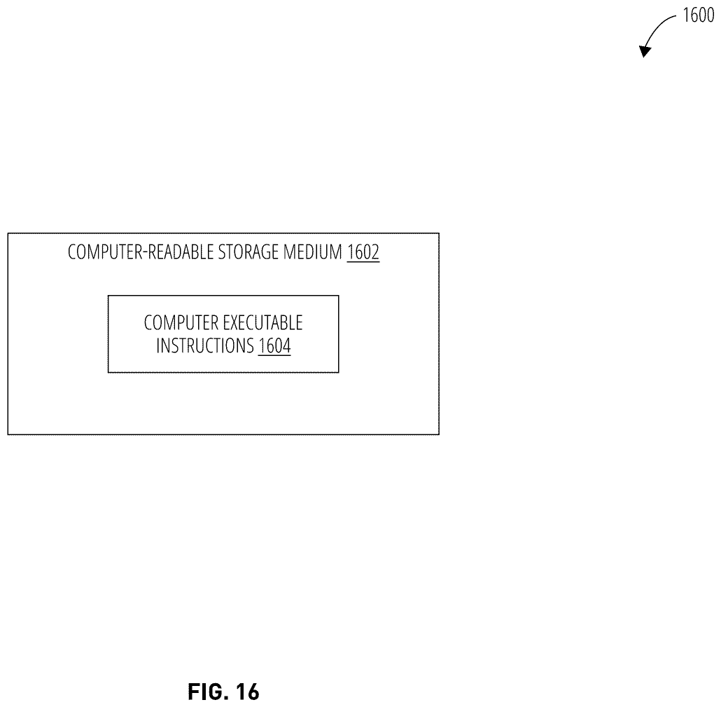

FIG. 16 illustrates an apparatus 1600. Apparatus 1600 comprises any non-transitory computer-readable storage medium 1602 or machine-readable storage medium, such as an optical, magnetic or semiconductor storage medium. In various embodiments, apparatus 1600 comprises an article of manufacture or a product. In some embodiments, the computer-readable storage medium 1602 stores computer executable instructions with which one or more processing devices or processing circuitry can execute. For example, computer executable instructions 1604 includes instructions to implement operations described with respect to any logic flows described herein. Examples of computer-readable storage medium 1602 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1604 include any suitable type of code, such as source code, compiled code, interpreted code, executable code, static code, dynamic code, object-oriented code, visual code, and the like.

FIG. 17 illustrates an embodiment of a computing architecture 1700. Computing architecture 1700 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1700 has a single processor with one core or more than one processor. Note that the term “processor” refers to a processor with a single core or a processor package with multiple processor cores. In at least one embodiment, the computing architecture 1700 is representative of the components of the system 200. More generally, the computing architecture 1700 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1700. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 17, computing architecture 1700 comprises a system-on-chip (SoC) 1702 for mounting platform components. System-on-chip (SoC) 1702 is a point-to-point (P2P) interconnect platform that includes a first processor 1704 and a second processor 1706 coupled via a point-to-point interconnect 1770 such as an Ultra Path Interconnect (UPI). In other embodiments, the computing architecture 1700 is another bus architecture, such as a multi-drop bus. Furthermore, each of processor 1704 and processor 1706 are processor packages with multiple processor cores including core(s) 1708 and core(s) 1710, respectively. While the computing architecture 1700 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1704 and chipset 1732. Some platforms include additional components and some platforms include sockets to mount the processors and/or the chipset. Furthermore, some platforms do not have sockets (e.g. SoC, or the like). Although depicted as a SoC 1702, one or more of the components of the SoC 1702 are included in a single die package, a multi-chip module (MCM), a multi-die package, a chiplet, a bridge, and/or an interposer. Therefore, embodiments are not limited to a SoC.

The processor 1704 and processor 1706 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1704 and/or processor 1706. Additionally, the processor 1704 need not be identical to processor 1706.

Processor 1704 includes an integrated memory controller (IMC) 1720 and point-to-point (P2P) interface 1724 and P2P interface 1728. Similarly, the processor 1706 includes an IMC 1722 as well as P2P interface 1726 and P2P interface 1730. IMC 1720 and IMC 1722 couple the processor 1704 and processor 1706, respectively, to respective memories (e.g., memory 1716 and memory 1718). Memory 1716 and memory 1718 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1716 and the memory 1718 locally attach to the respective processors (i.e., processor 1704 and processor 1706). In other embodiments, the main memory couple with the processors via a bus and shared memory hub. Processor 1704 includes registers 1712 and processor 1706 includes registers 1714.

Computing architecture 1700 includes chipset 1732 coupled to processor 1704 and processor 1706. Furthermore, chipset 1732 are coupled to storage device 1750, for example, via an interface (I/F) 1738. The I/F 1738 may be, for example, a Peripheral Component Interconnect-enhanced (PCIe) interface, a Compute Express Link® (CXL) interface, or a Universal Chiplet Interconnect Express (UCIe) interface. Storage device 1750 stores instructions executable by circuitry of computing architecture 1700 (e.g., processor 1704, processor 1706, GPU 1748, accelerator 1754, vision processing unit 1756, or the like). For example, storage device 1750 can store instructions for the client device 202, the client device 206, the inferencing device 204, the training device 1102, or the like.

Processor 1704 couples to the chipset 1732 via P2P interface 1728 and P2P 1734 while processor 1706 couples to the chipset 1732 via P2P interface 1730 and P2P 1736. Direct media interface (DMI) 1776 and DMI 1778 couple the P2P interface 1728 and the P2P 1734 and the P2P interface 1730 and P2P 1736, respectively. DMI 1776 and DMI 1778 is a high-speed interconnect that facilitates, e.g., eight Giga Transfers per second (GT/s) such as DMI 3.0. In other embodiments, the processor 1704 and processor 1706 interconnect via a bus.

The chipset 1732 comprises a controller hub such as a platform controller hub (PCH). The chipset 1732 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1732 comprises more than one controller hub such as a chipset with a memory controller hub, a graphics controller hub, and an input/output (I/O) controller hub.

In the depicted example, chipset 1732 couples with a trusted platform module (TPM) 1744 and UEFI, BIOS, FLASH circuitry 1746 via I/F 1742. The TPM 1744 is a dedicated microcontroller designed to secure hardware by integrating cryptographic keys into devices. The UEFI, BIOS, FLASH circuitry 1746 may provide pre-boot code. The I/F 1742 may also be coupled to a network interface circuit (NIC) 1780 for connections off-chip.

Furthermore, chipset 1732 includes the I/F 1738 to couple chipset 1732 with a high-performance graphics engine, such as, graphics processing circuitry or a graphics processing unit (GPU) 1748. In other embodiments, the computing architecture 1700 includes a flexible display interface (FDI) (not shown) between the processor 1704 and/or the processor 1706 and the chipset 1732. The FDI interconnects a graphics processor core in one or more of processor 1704 and/or processor 1706 with the chipset 1732.

The computing architecture 1700 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1754 and/or vision processing unit 1756 are coupled to chipset 1732 via I/F 1738. The accelerator 1754 is representative of any type of accelerator device (e.g., a data streaming accelerator, cryptographic accelerator, cryptographic co-processor, an offload engine, etc.). One example of an accelerator 1754 is the Intel® Data Streaming Accelerator (DSA). The accelerator 1754 is a device including circuitry to accelerate copy operations, data encryption, hash value computation, data comparison operations (including comparison of data in memory 1716 and/or memory 1718), and/or data compression. Examples for the accelerator 1754 include a USB device, PCI device, PCIe device, CXL device, UCIe device, and/or an SPI device. The accelerator 1754 also includes circuitry arranged to execute machine learning (ML) related operations (e.g., training, inference, etc.) for ML models. Generally, the accelerator 1754 is specially designed to perform computationally intensive operations, such as hash value computations, comparison operations, cryptographic operations, and/or compression operations, in a manner that is more efficient than when performed by the processor 1704 or processor 1706. Because the load of the computing architecture 1700 includes hash value computations, comparison operations, cryptographic operations, and/or compression operations, the accelerator 1754 greatly increases performance of the computing architecture 1700 for these operations.

The accelerator 1754 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1754. For example, the accelerator 1754 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1754 via a non-posted write (e.g., a deferred memory write (DMWr)). One example of an instruction that atomically submits a work descriptor to the shared work queue of the accelerator 1754 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1754. The dedicated work queue may accept job submissions via commands such as the movdir64b instruction.

Various I/O devices 1760 and display 1752 couple to the bus 1772, along with a bus bridge 1758 which couples the bus 1772 to a second bus 1774 and an I/F 1740 that connects the bus 1772 with the chipset 1732. In one embodiment, the second bus 1774 is a low pin count (LPC) bus. Various input/output (I/O) devices couple to the second bus 1774 including, for example, a keyboard 1762, a mouse 1764 and communication devices 1766.

Furthermore, an audio I/O 1768 couples to second bus 1774. Many of the I/O devices 1760 and communication devices 1766 reside on the system-on-chip (SoC) 1702 while the keyboard 1762 and the mouse 1764 are add-on peripherals. In other embodiments, some or all the I/O devices 1760 and communication devices 1766 are add-on peripherals and do not reside on the system-on-chip (SoC) 1702.

FIG. 18 illustrates a block diagram of an exemplary communications architecture 1800 suitable for implementing various embodiments as previously described. The communications architecture 1800 includes various common communications elements, such as a transmitter, receiver, transceiver, radio, network interface, baseband processor, antenna, amplifiers, filters, power supplies, and so forth. The embodiments, however, are not limited to implementation by the communications architecture 1800.

As shown in FIG. 18, the communications architecture 1800 includes one or more clients 1802 and servers 1804. The clients 1802 and the servers 1804 are operatively connected to one or more respective client data stores 1808 and server data stores 1810 that can be employed to store information local to the respective clients 1802 and servers 1804, such as cookies and/or associated contextual information.

The clients 1802 and the servers 1804 communicate information between each other using a communication framework 1806. The communication framework 1806 implements any well-known communications techniques and protocols. The communication framework 1806 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1806 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/200/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1802 and the servers 1804. A communications network is any one and the combination of wired and/or wireless networks including without limitation a direct interconnection, a secured custom connection, a private network (e.g., an enterprise intranet), a public network (e.g., the Internet), a Personal Arca Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice.

According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

What is claimed is:

1. A method, comprising:
receiving an input vector comprising a first vector and a second vector by a multi-tower machine learning (ML) model for a content delivery system of a connection network system, the first vector comprising user features and the second vector comprising campaign features of a content delivery campaign managed by the content delivery system, wherein the multi-tower model operates in an offline execution pipeline and an online execution pipeline of the content delivery system of the connection network system;
generating a set of user embeddings from the first vector by a first tower of the multi-tower ML model based on the user features representing user data and activity data associated with users of the connection network system;
generating a set of campaign embeddings from the second vector by a second tower of the multi-tower ML model based on the campaign features;
generating a metric based on the set of user embeddings and the set of campaign embeddings, the metric representing a probability of an interaction between a user identifier and a content item associated with the content delivery campaign;
selecting audience user identifiers for a user audience for a campaign stage of multiple campaign stages of the content delivery campaign based on the metric in the offline execution pipeline; and
sending a content item for the content delivery campaign to an electronic device associated with the user audience in the online execution pipeline.

2. The method of claim 1, comprising receiving a textual description for the campaign features from a generative artificial intelligence (AI) model.

3. The method of claim 1, comprising:
matching one or more user embeddings with one or more campaign embeddings using a similarity measure to form a set of matched embeddings; and
generating the metric based on the matched embeddings.

4. The method of claim 1, comprising:
generating a training dataset comprising one or more training datapoints, wherein a training datapoint represents a click action on a landing web page of the connection network system; and
training the multi-tower ML model using the training dataset.

5. The method of claim 1, comprising:
receiving a concatenated vector by the first tower of the multi-tower ML model;
extracting behavioral pattern features from content item activity data and organic content activity data using a behavioral pattern extraction layer of the first tower;
encoding a set of user interaction features based on the behavioral pattern features using a user feature interaction layer of the first tower;
generating a user embedding based on the user interaction features using a fully connected layer of the first tower, the fully connected layer comprising neurons using a hyperbolic tangent (tanh) as an activation function.

6. The method of claim 1, comprising:
receiving a concatenated vector by the second tower of the multi-tower ML model;
encoding a set of campaign interaction features based on the textual descriptions of the content delivery campaign using a campaign feature interaction layer of the second tower;
generating a campaign embedding based on the campaign interaction features using a fully connected layer of the second tower, the fully connected layer comprising neurons using a hyperbolic tangent (tanh) as an activation function.

7. The method of claim 1, comprising selecting the user identifiers from a pool of user identifiers based on the metric in multiple campaign stages of the content delivery campaign in the offline execution pipeline, each campaign stage generating data identifying a set of candidate user identifiers for the user audience for the content delivery campaign.

8. The method of claim 1, comprising:
determining a first set of candidate user identifiers or a second set of candidate user identifiers for a first campaign stage or a second campaign stage, respectively, is complete and ready for addition to the user audience of the content delivery campaign in the offline execution pipeline of the content delivery system; and
merging the first set of candidate user identifiers or the second set of candidate user identifiers with the audience user identifiers of the user audience of the content delivery campaign based on a set of merge rules executed by merge logic in the online execution pipeline of the content delivery system.

9. The method of claim 1, comprising:
detecting a user reset event of a campaign attribute of the content delivery campaign;
retrieving a set of user events associated with the content delivery campaign;
retrieving a first set of candidate user identifiers and a second set of candidate user identifiers from a first campaign stage and a second campaign stage, respectively;
merging the first set of candidate user identifiers and the second set of candidate user identifiers based on a set of merge rules executed by merge logic in the offline execution pipeline of the content delivery system.

10. The method of claim 9, wherein the merging comprises:
detecting a user reset event;
retrieving a campaign version value for the content delivery campaign; and
overwriting candidate user identifiers for a campaign stage based on the campaign version.

11. A computing apparatus comprising:
circuitry; and
a memory storing instructions that, when executed by the circuitry, causes the circuitry to:
receive an input vector comprising a first vector and a second vector by a multi-tower machine learning (ML) model for a content delivery system of a connection network system, the first vector comprising user features and the second vector comprising campaign features of a content delivery campaign managed by the content delivery system, wherein the multi-tower model operates in an offline execution pipeline and an online execution pipeline of the content delivery system of the connection network system;
generate a set of user embeddings from the first vector by a first tower of the multi-tower ML model based on the user features representing user data and activity data associated with users of the connection network system;
generate a set of campaign embeddings from the second vector by a second tower of the multi-tower ML model based on the campaign features;
generate a metric based on the set of user embeddings and the set of campaign embeddings, the metric representing a probability of an interaction between a user identifier and a content item associated with the content delivery campaign;
select audience user identifiers for a user audience for a campaign stage of multiple campaign stages of the content delivery campaign based on the metric in the offline execution pipeline; and
send a content item for the content delivery campaign to electronic devices associated with the user audience in the online execution pipeline.

12. The computing apparatus of claim 11, the circuitry to receive a textual description for the campaign features from a generative artificial intelligence (AI) model.

13. The computing apparatus of claim 11, the circuitry to:
generate a training dataset comprising one or more training datapoints, wherein a training datapoint represents a click action on a landing web page of the connection network system; and
train the multi-tower ML model using the training dataset.

14. The computing apparatus of claim 11, the circuitry to:
determine a first set of candidate user identifiers or a second set of candidate user identifiers for a first campaign stage or a second campaign stage, respectively, is complete and ready for addition to the user audience of the content delivery campaign in the offline execution pipeline of the content delivery system; and
merge the first set of candidate user identifiers or the second set of candidate user identifiers with the audience user identifiers of the user audience of the content delivery campaign based on a set of merge rules executed by merge logic in the online execution pipeline of the content delivery system.

15. The computing apparatus of claim 11, the circuitry to:
detect a user reset event of a campaign attribute of the content delivery campaign;
retrieve a set of user events associated with the content delivery campaign;
retrieve a first set of candidate user identifiers and a second set of candidate user identifiers from a first campaign stage and a second campaign stage, respectively;
merge the first set of candidate user identifiers and the second set of candidate user identifiers based on a set of merge rules executed by merge logic in the offline execution pipeline of the content delivery system.

16. A non-transitory computer-readable storage medium, the computer-readable storage medium including instructions that when executed by circuitry, cause the circuitry to:
receive an input vector comprising a first vector and a second vector by a multi-tower machine learning (ML) model for a content delivery system of a connection network system, the first vector comprising user features and the second vector comprising campaign features of a content delivery campaign managed by the content delivery system, wherein the multi-tower model operates in an offline execution pipeline and an online execution pipeline of the content delivery system of the connection network system;
generate a set of user embeddings from the first vector by a first tower of the multi-tower ML model based on the user features representing user data and activity data associated with users of the connection network system;
generate a set of campaign embeddings from the second vector by a second tower of the multi-tower ML model based on the campaign features;
generate a metric based on the set of user embeddings and the set of campaign embeddings, the metric representing a probability of an interaction between a user identifier and a content item associated with the content delivery campaign;
select audience user identifiers for a user audience for a campaign stage of multiple campaign stages of the content delivery campaign based on the metric in the offline execution pipeline; and
send a content item for the content delivery campaign to electronic devices associated with the user audience in the online execution pipeline.

17. The computer-readable storage medium of claim 16, comprising instructions that when executed by circuitry, cause the circuitry to receive a textual description for the campaign features from a generative artificial intelligence (AI) model.

18. The computer-readable storage medium of claim 16, comprising instructions that when executed by circuitry, cause the circuitry to:
generate a training dataset comprising one or more training datapoints, wherein a training datapoint represents a click action on a landing web page of the connection network system; and
train the multi-tower ML model using the training dataset.

19. The computer-readable storage medium of claim 16, comprising instructions that when executed by circuitry, cause the circuitry to:
determine a first set of candidate user identifiers or a second set of candidate user identifiers for a first campaign stage or a second campaign stage, respectively, is complete and ready for addition to the user audience of the content delivery campaign in the offline execution pipeline of the content delivery system; and
merge the first set of candidate user identifiers or the second set of candidate user identifiers with the audience user identifiers of the user audience of the content delivery campaign based on a set of merge rules executed by merge logic in the online execution pipeline of the content delivery system.

20. The computer-readable storage medium of claim 16, comprising instructions that when executed by circuitry, cause the circuitry to:
detect a user reset event of a campaign attribute of the content delivery campaign;
retrieve a set of user events associated with the content delivery campaign;
retrieve a first set of candidate user identifiers and a second set of candidate user identifiers from a first campaign stage and a second campaign stage, respectively;
merge the first set of candidate user identifiers and the second set of candidate user identifiers based on a set of merge rules executed by merge logic in the offline execution pipeline of the content delivery system.
